(19) United States
(12) Patent Application Publication
(10) Pub. No.: US 2013/0191159 A1
(43) Pub. Date: Jul. 25, 2013

(54) SYSTEM, METHOD AND COMPUTER PROGRAM PRODUCT FOR CUSTOMER-SELECTED CARE PATH FOR TREATMENT OF A MEDICAL CONDITION

(71) Applicant: UnitedHealth Group Incorporated, Minnetonka, MN (US)

(72) Inventors: Godofredo T. Camacho, St. Paul, MN (US); Karl J. Ulfers, Minneapolis, MN (US); Imad Ahmed, North Oaks, MN (US); Lauri R. Middleton, Cape Neddick, ME (US)

(73) Assignee: UnitedHealth Group Incorporated, Minnetonka, MN (US)

(21) Appl. No.: 13/745,542

(22) Filed: Jan. 18, 2013

Related U.S. Application Data
(63) Continuation-in-part of application No. 13/354,019, filed on Jan. 19, 2012.

(51) Int. Cl. G06F 19/00; G06Q 50/22

(52) U.S. Cl. CPC G06F 19/34; G06Q 50/22
USPC 705/3

(57) ABSTRACT

Consumer healthcare decisions are facilitated using systems, methods and computer program products configured to generate healthcare path recommendations based a consumer engagement with a consumer interface in which consumer-reported information related to a consumer health condition is received and used to generate healthcare path recommendations. The healthcare path recommendations are customized for the consumer based on the consumer's personalized information including the consumer's engagement with the consumer interface. The customized healthcare paths include treatment options for addressing the health of the consumer and may include cost-effective providers.

### FIELD OF THE INVENTION

The present disclosure relates to a system, method, and computer program product that provides care path information for a medical condition or medical indication from which a consumer may select a care path, provides information on providers to enable consumers to select providers, and provides cost information related to care paths. In further aspects, the present disclosure relates to computer-implemented systems and methods and computer program products configured to facilitate consumer healthcare decisions by providing a consumer with customized healthcare path recommendations and support.

### BACKGROUND OF THE INVENTION

As will be appreciated by those having ordinary skill in the art, there may be numerous treatment possibilities for any given medical condition. For example, there are numerous medications available for the treatment of certain cardiac conditions, such as high blood pressure, high cholesterol, or other cardiac conditions. Alternatively, non-medication avenues for treatment may be available, such as surgery. What is needed therefore are systems and methods to help the healthcare consumer choose and evaluate the quality and/or cost of various healthcare options to achieve targeted medical goals.

Also, each treatment option may have one or more providers available to provide treatment. Currently, it is very difficult for a consumer to select one or more providers. There is a need for a system to enable consumers to select providers. Consumers need to have access to information that helps them select among available providers based on quality and/or cost, for example.

Furthermore, there are costs associated with each treatment option. Depending on the consumer's budget, certain treatment options may be more affordable. There is a need for a system that provides cost information for each step involved in a treatment option.

What is further needed is a system and method for providing consumers with health treatment options, based on quality and cost estimates, to provide the consumer greater clarity in selecting from among a variety of medical treatment options.

In short, healthcare consumers have an increasing need to find value in their search for quality healthcare options. Healthcare consumers have an increasing need for transparency in their search for healthcare options. Moreover, with regard to a given health care option, healthcare consumers have a need to understand the costs involved in each of the steps involved in a particular healthcare option.

### SUMMARY OF THE INVENTION

According to certain implementations, a computer-implemented method for providing customized healthcare path recommendations uses a computer processor to receive consumer-reported information that includes at least one of symptoms, conditions, or past medical procedures, which may be received during a consumer engagement with a consumer interface communicatively coupled to the computer processor. Healthcare path recommendations are generated using consumer-reported information and consumer medical information stored in a database coupled to the computer processor. Healthcare path recommendations are transmitted to the consumer interface for display and personalized information for the consumer is received based on the recommendations displayed and based on the consumer's engagement with the consumer interface. Customized healthcare path recommendations are generated based on the received personalized information and the consumer engagement. The customized healthcare path recommendations include treatment options for addressing the health of the consumer with cost-effective providers. The customized healthcare path recommendations are transmitted to the consumer interface during the consumer engagement.

According to another implementation, a computer-implemented method for providing a consumer with customized healthcare path recommendations involves using a computer processor to receive consumer-reported information such as symptoms, conditions and/or procedures related to a consumer health condition during a consumer engagement with a consumer interface communicatively coupled to the processor. Healthcare path recommendations are generated based on the consumer-reported information and on consumer medical information stored in a database coupled to the computer processor. Personalized information for the consumer is received based on and consumer engagement activities with the consumer interface and from the database storing the consumer medical information, the personalized information from the database received based on the consumer-reported information. Customized healthcare path recommendations are generated based on the received personalized information and include treatment options for addressing the consumer health condition. The customized healthcare path recommendations are transmitted to the consumer interface for display during the consumer engagement.

### BRIEF DESCRIPTION OF THE DRAWINGS

FIG. 1 illustrates an example of a block diagram of a care path navigator application accessible to users over a network, in accordance with one embodiment of the present disclosure.

FIG. 2 illustrates various data sources and types that may be used in systems, methods, and products of the present disclosure, according to one embodiment.

FIG. 3 illustrates data sources and types that may be used to perform capabilities of the present disclosure which may be delivered to a user in accordance with an embodiment of the present disclosure.

FIG. 4A illustrates an example healthcare path map in accordance with an embodiment of the present disclosure.

FIG. 4B illustrates another example healthcare path map in accordance with an embodiment of the present disclosure.

FIG. 5 details aspects of a healthcare path in accordance with an embodiment of the present disclosure.

FIG. 6 shows general and specific aspects of a treatment care path in accordance with an embodiment of the present disclosure.

FIGS. 7 and 8 show aspects of systems and methods of the present disclosure related to obtaining accurate cost estimates in accordance with an embodiment of the present disclosure.

FIGS. 9A and 9B illustrate an optimization procedure among various healthcare options within a healthcare path in accordance with an embodiment of the present disclosure.

FIG. 10 illustrates an example healthcare path display in accordance with an embodiment of the present disclosure.

FIG. 11A illustrates another example healthcare path display in accordance with an embodiment of the present disclosure.

FIG. 11B illustrates information provided on a user display related to a particular care path in accordance with one embodiment of the present disclosure.

FIG. 11C illustrates information provided on a user display related to choosing a particular provider in accordance with one embodiment of the present disclosure.

FIG. 12 illustrates an electronic advice module in accordance with the present disclosure.

FIG. 13 illustrates a return on investment module in accordance with the present disclosure

FIG. 14 illustrates an electronic consumer report card in accordance with the present disclosure.

FIG. 15 illustrates an example of a block diagram of a consumer health management system configured to generate customized healthcare path recommendations in accordance with the present disclosure.

FIG. 16 illustrates an example of a block diagram of an implementation of the consumer health management system in which a consumer may review and make selections in connection with their customized healthcare path recommendations in accordance with the present disclosure.

FIG. 17A illustrates a flow diagram of a method for facilitating consumer healthcare decisions through providing customized healthcare path recommendations in accordance with the present disclosure.

FIG. 17B illustrates a flow diagram of a method for providing customized healthcare path recommendations in accordance with the present disclosure.

FIG. 18A illustrates a user interface configured to receive consumer-reported information for generating healthcare path recommendations in accordance with the present disclosure.

FIG. 18B illustrates a process flow for a consumer engaging with the consumer health management system in accordance with the present disclosure.

FIG. 18C illustrates a user interface listing healthcare path recommendations generated based on personalized information in accordance with the present disclosure.

### DETAILED DESCRIPTION

The present disclosure discloses a system, method, and computer product that, in one embodiment, will provide consumers with information about various treatment options as well as information about each of the steps included in the care path involved in a particular treatment option. In this aspect of the present disclosure, a healthcare consumer may use this information to make an informed decision about which healthcare option to select, including which care path. As such, this information enables the healthcare consumer to select a healthcare option that is best suited to his/her needs.

The present disclosure also discloses a system, method, and computer product that, in one embodiment, will provide consumers with information regarding providers for each step in a medical treatment option. The provider information may be based on quality and/or cost, for example. This information will enable a healthcare consumer to make an informed selection of one or more providers for a particular treatment option. Unless otherwise stated, the term “provider” as used herein may refer to one or more physicians and/or one or more facilities.

Furthermore, the present disclosure discloses a system, method, and computer product that, in one embodiment, will provide cost estimates for each step of a medical treatment option as well as an aggregate cost for the selected option as a whole. This cost estimate will preferably be based on average costs calculated from claim information from the providers involved as well as the facilities involved. The cost estimate may also be based on geographic averages. It will be understood, however, that the cost estimate may be based on any other relevant data sources or combination of sources.

In one aspect of the present disclosure, a system and method is provided that sets forth the available treatment options for a particular medical condition. Medical cost estimates are provided to the healthcare consumer, along with an expected health outcome of such treatment. In this manner, the healthcare consumer is able to more transparently see and compare the costs versus potential outcomes of various medical procedures to treat a condition.

Medical cost data may be provided by geographic region. Alternatively, and preferably, medical cost data may be provided by a database of prior claims. Further alternatively, and more preferably, medical cost data may be provided by a fee schedule of the provider. One or more sources of medical cost data may be used to provide a cost estimate in accordance with the present disclosure.

In a further aspect of medical cost data, it may be desirable, in some examples, to use “cross-platform” data, wherein the prior claims data of one entity is made available to another entity. As such, the claims data “pool” of information may be broader, and more accurate medical cost estimates may be desirably achieved.

It will further be appreciated that medical conditions may require more than one treatment. For example, a medical condition such as a broken leg may first require surgery, and may thereafter require outpatient therapy, medication, outpatient visits, or a combination of the above. As such, when evaluating a medical treatment option, the entire course of treatment may be evaluated, which may be referred to herein as a healthcare path. Thus, when the healthcare consumer evaluates the outcomes and costs of various methods of treatment, the entire path of a particular healthcare course of treatment may be evaluated to determine the overall costs, outcomes, and goals.

As discussed above, the treatments of a medical condition may generally be referred to as a course of treatment. A course of treatment may include a number of medical services, and a number of service categories, which may be offered by one or more medical professionals, and one or more medical facilities. The present disclosure has provided systems and methods for evaluating the costs of a particular treatment. Such treatment, as will be presently described, may be a part of a larger course of treatment, for any given category of medical service, provided by any medical professional, at any medical facility. For any course of treatment, one or more individual treatments may be combined, as discussed above, to achieve a desired result in a course of medical treatment. Such course of treatment may be given over time, and each component thereof may include an individual cost.

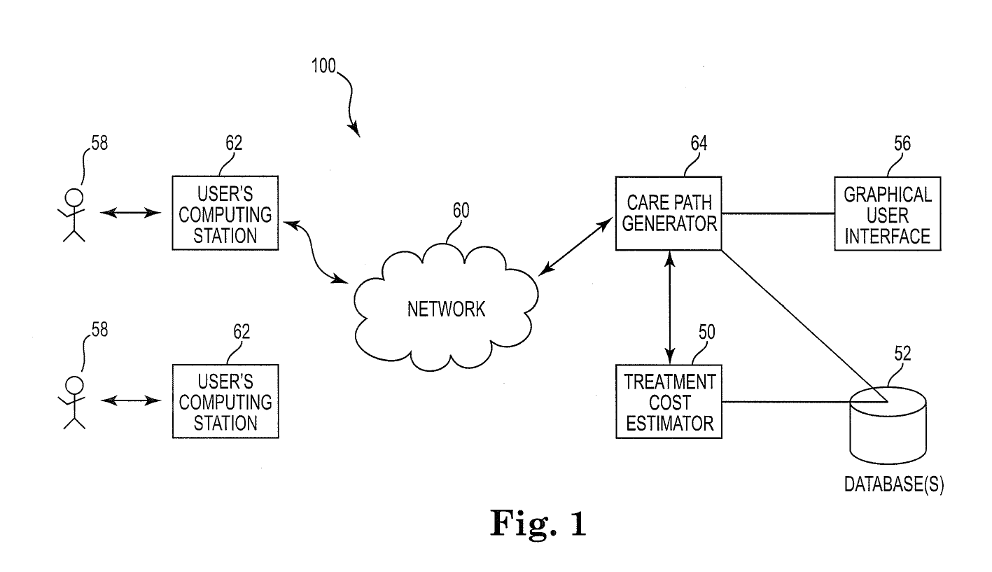

Referring to FIG. 1, a care path navigator 64 for providing one or more care paths or portions thereof is illustrated in accordance with an embodiment of the present disclosure. As shown in FIG. 1, the care path navigator 64 may be provided as a computer program (i.e., an application program) or hardware device accessing one or more databases 52 and/or other computer programs such as a treatment cost estimator 50 for calculating or estimating healthcare or medical treatment costs. It will be understood that the care path navigator 64 may integrate a cost estimator as an integral part of the care path navigator program, or the care path navigator program may access and utilize one or more additional computer programs to determine cost estimates for one or more treatments. An exemplary treatment cost estimation program that may be integrated with or used in addition to the systems, methods, and computer products of the present disclosure is described in detail in U.S. application Ser. No. 10/966,530, filed Oct. 15, 2004, now U.S. Pat. No. 8,005,687, entitled “SYSTEM, METHOD AND COMPUTER PROGRAM PRODUCT FOR ESTIMATING MEDICAL COSTS,” filed Oct. 15, 2003, which is hereby incorporated herein in its entirety. It will further be understood that the care path navigator 64 may generate not only one or more care paths or portions thereof but may also generate other results related to one or more care paths as disclosed herein, for example the cost of one or more care paths and/or portions thereof, the optimal care path, etc. A graphical user interface 56, having one or more display screens, may also be provided or be in communication with the care path navigator application 64, wherein the graphical user interface 56 provides users 58 with the ability to input data necessary for the care path navigator 64 to generate one or more care paths or portions thereof, as well as to provides users 58 with various displays of the resulting data.

The one or more database 52 may access or include any suitable data that may be used to generate one or more care paths or portions thereof. Specifically, embodiments of the present disclosure may include databases with data related to one or more health plan members that may include information related to the member's medical coverage, medical conditions, medical history, etc.; databases with data related to one or more health plans including for example coverage amounts, deductibles, coinsurance, and/or co-pays, etc.; databases with data related to treatment including treatment options for particular conditions, illnesses and/or health states, etc.; databases with data related to cost data, for example, cost of services, which may be provided in a variety of different formats, for example cost of services by treatment, cost of services by provider, and/or cost of services by location or geography, for example; databases with data related to provider selection, for example provider cost, provider quality, provider outcomes data, and/or consumer feedback, for example. It will be understood that any other suitable data may be included in the systems, methods and products of the present disclosure.

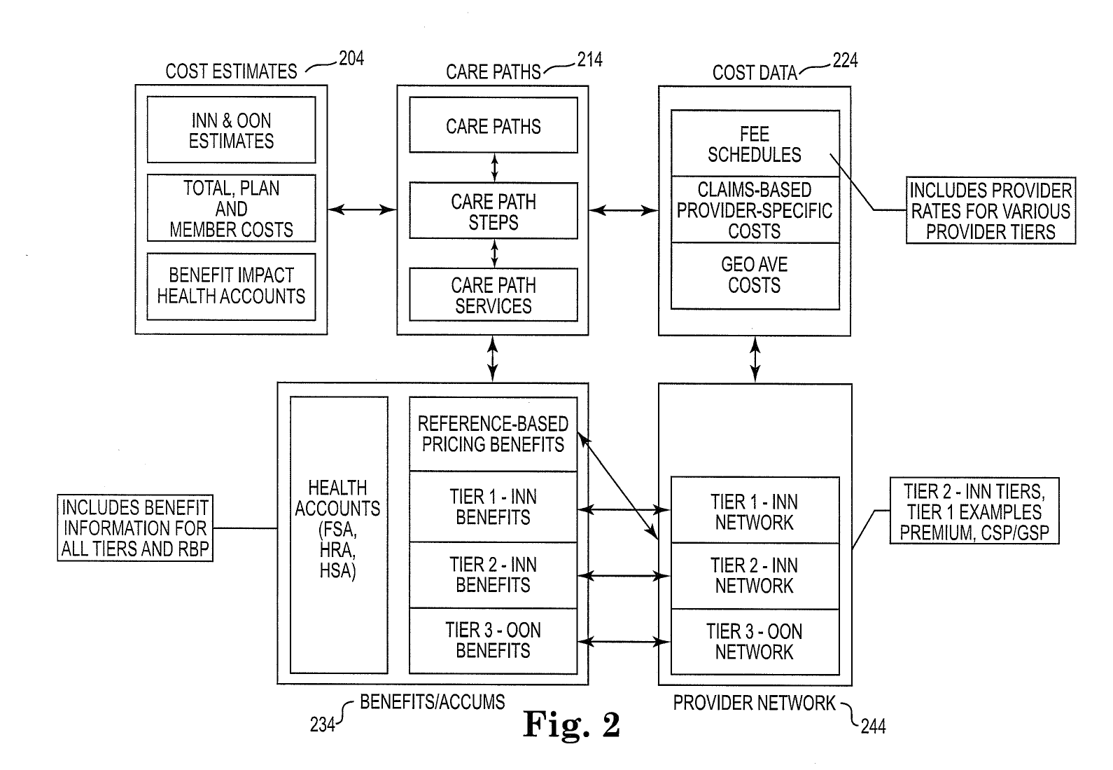

FIG. 2 shows an embodiment of the types of linkages that may be included in the system between the various sources of data in order for the care path navigator to provide desired outputs. As may be seen, generally five sources or types of data may be included in some embodiments of the system, data related to: cost estimates 204, which may include in-network and out-of-network estimates, total, plan and member costs, and benefit impact health accounts, for example; care paths 214, which may include data related to care paths, care path steps, and care path services, for example; cost data 224, which may include fee schedules, claims-based provider-specific costs (which may include episode of care data generated for example by means of a “grouper”), and geographical average costs; provider network data 244, which may include tier 1 in-network networks, tier 2 in-network networks, and tier 3 out-of-network networks data, for example; and benefits/accumulations data 234, which may include reference-based pricing benefits, tier 1 in-network benefits, tier 2 in-network benefits, and tier 3 out-of-network benefits, for example. While five sources and/or types of data have been described, it will be understood that any other suitable source or type of data may be incorporated into embodiments of the present disclosure. As may be seen, the various data sources and types may be advantageously linked to provide a system that provides care path outputs that may help a consumer make an informed, cost-effective, and/or appropriate decision related to their health care needs and/or goals.

With reference back to FIG. 1, the care path navigator 64 is preferably accessible over a network 60, such as the Internet or any other conventional network including but not limited to Ethernets, wired or wireless networks or links, virtual private networks, or the like, for users 58 to access the care path navigator 64 application program 64 and to view the results produced thereby. In one example, a user's computing station 62 is equipped with a browser program, such as Microsoft's Internet Explorer™, Netscape's Navigator™, a Linux browser, or other browsing application program, viewing program or other software, which provides the user 58 with access to the care path navigator application program 64. The user's computing station 62 may be any conventional computing device or process, such as but not limited to a computer, personal data assistant (PDA), mobile phone, wireless device, tablet computer, terminal, or the like.

In another embodiment, the network 60 may be part of a company's intranet network wherein employees 58 access a care path navigator program 64 through the company's intranet 60 in order to obtain one or more care paths or portions thereof and associated estimates for same.

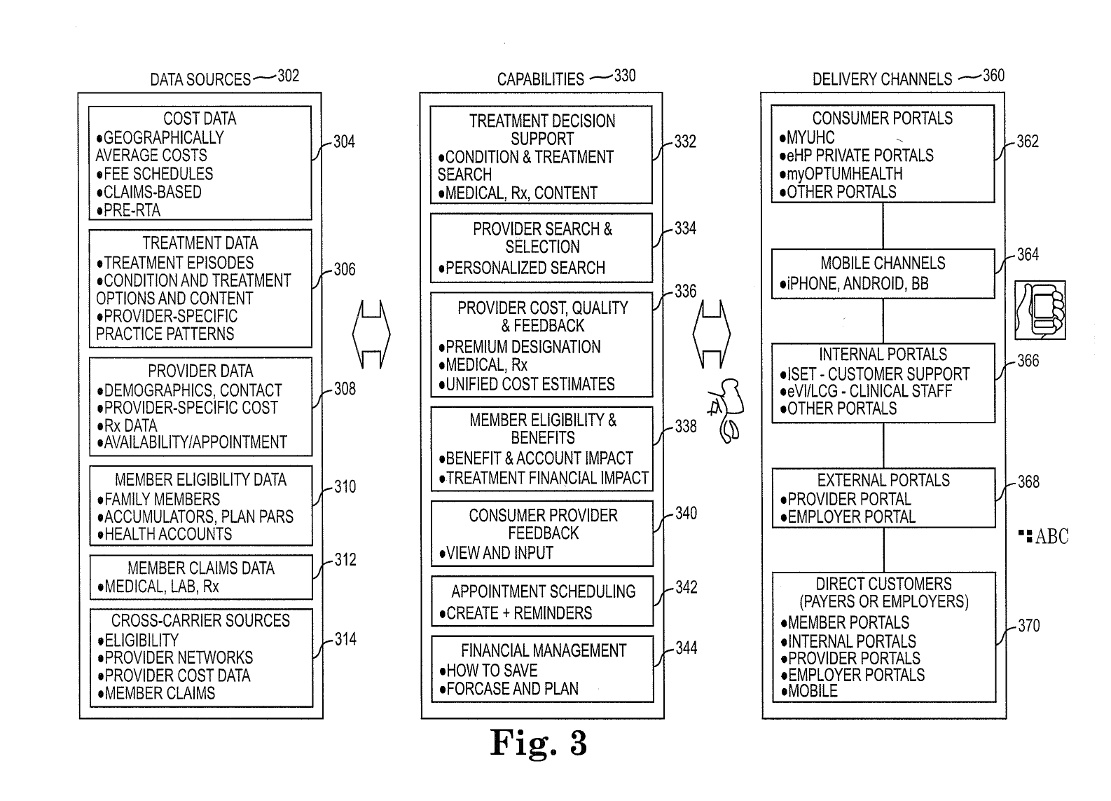

Generally, the system 100 of the present disclosure may use various data sources to provide outputs in a variety of different ways. FIG. 3 shows the data sources 302, capabilities 330, and delivery channels 360 that may be included in some embodiments of the present disclosure. As described herein, any useful and appropriate data may be included and used within the systems, methods, and products of the present disclosure. For example data sources 302 may include cost data 304, treatment data 306, provider data 308, member eligibility data 310, member claims data 312, and/or cross-carrier sources 314 for example. Such data may be used in embodiments of the present system to provide certain capabilities 330, for example, but not limited to: treatment decision support 332; provider search and selection 334; provider cost, quality and feedback 336; member eligibility and benefits 338; consumer provider feedback 340; appointment scheduling 342; and/or financial management 344 for example. The user of the systems, methods, and products of the present disclosure may access the capabilities 330 by one or more of the following methods, but are not so limited: via consumer portals 362; mobile channels 364; internal portals 368; and/or direct customers 370 for example.

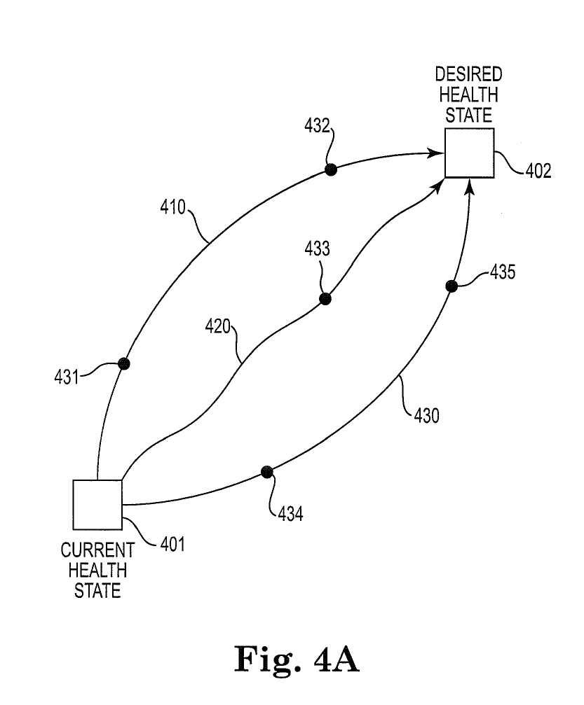

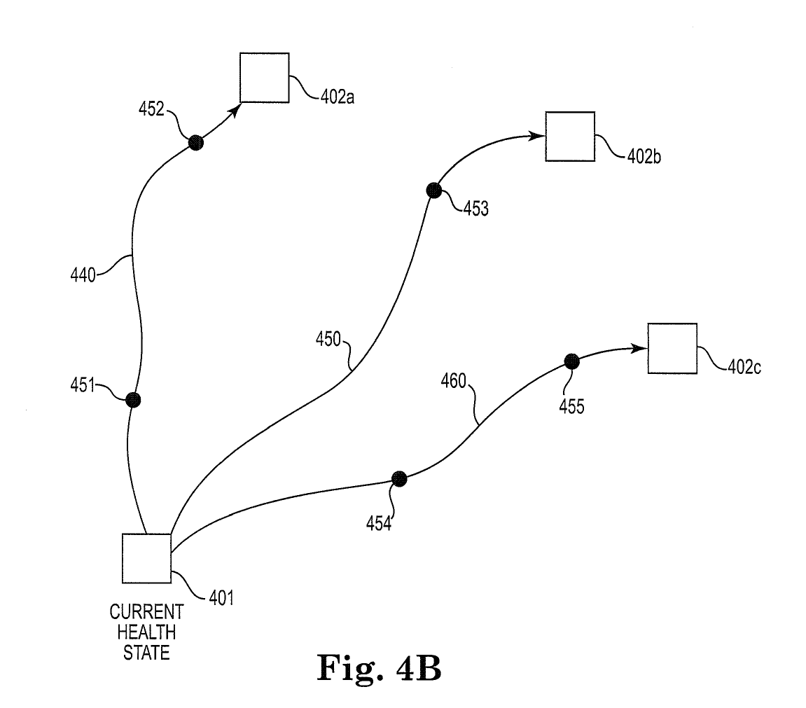

Various medical treatment paths, or healthcare paths, will now be discussed with respect to the systems and methods of the present disclosure. An example series of treatment paths is shown in FIG. 4A, which depicts a current health state 401, and a desired health state 402. The healthcare consumer, as shown in this figure, is currently at current health state 401, and is desirous of medical treatment that will bring such consumer to desired health state 402. In order to achieve desired health state 402, one of three, for example, series of treatments is possible, shown in the figure as treatment path 410, treatment path 420, and treatment path 430. As previously discussed, any treatment path may have one or more individual treatments, each having its own costs and potential outcome, and may be available at a plurality of service providers by a plurality of healthcare professionals. For example, as shown in FIG. 4A, treatment path 410 includes individual treatments 431 and 432. Treatment path 420 includes just one treatment 433. Further, treatment path 430 includes individual treatments 434 and 435. FIG. 4A merely provides an example depiction of treatment options, and it will be appreciated that the path from a current health state to a desired health state may include more or fewer than three options, each comprising more or fewer than the number of individual treatments shown.

In another example, in FIG. 4B, a healthcare consumer having a current health state 401 may have more than one desired health state option. For example, the treatment of a medical condition may result in more than one health outcome, and the healthcare consumer may be desirous of comparing the costs and treatment options to achieve a plurality of healthcare outcomes, i.e., achieving one of the plurality of possible healthcare states. As shown in FIG. 4B, the current health state 401 may result in three possible health outcomes, that is, three healthcare states 402a, 402b, and 402c. The healthcare path 440 from the current state 401 to health state 402a may include treatments 451 and 452. The healthcare path 450 from the current state 401 to health state 402b may include treatments 453. Further, for healthcare path 460, which leads to health state 402c after treatment, may include treatments 454 and 455. Again, FIG. 4B merely provides an example depiction of treatment options, and it will be appreciated that the path from a current health state to a desired health states may include more or fewer than three options, each comprising more or fewer than the number of individual treatments shown.

By providing cost and treatment estimates for a plurality of treatment paths between a given current health state and one or more future or desired health states, the presently described system and method may save healthcare consumers time and money in a fragmented and complex health care system by providing a clear path to follow to meet their health care needs. Further, the presently described system and method allows the healthcare consumer to choose from one or more options, based on treatment outcomes and potential costs, thereby advantageously giving the healthcare consumer a greater freedom of choice in making healthcare decisions.

The aspects of an individual healthcare path will now be described in greater detail. As discussed above, with regard to the various systems and methods for estimating an individual treatment cost, it will be appreciated that any given healthcare path may include a selection from one of a plurality of treatment options, a plurality of treatment facilities, and may be given by a plurality of healthcare professionals. As such, a healthcare path may seek to provide the consumer with recommendations based on cost, availability, and treatment selections, for any given medical condition.

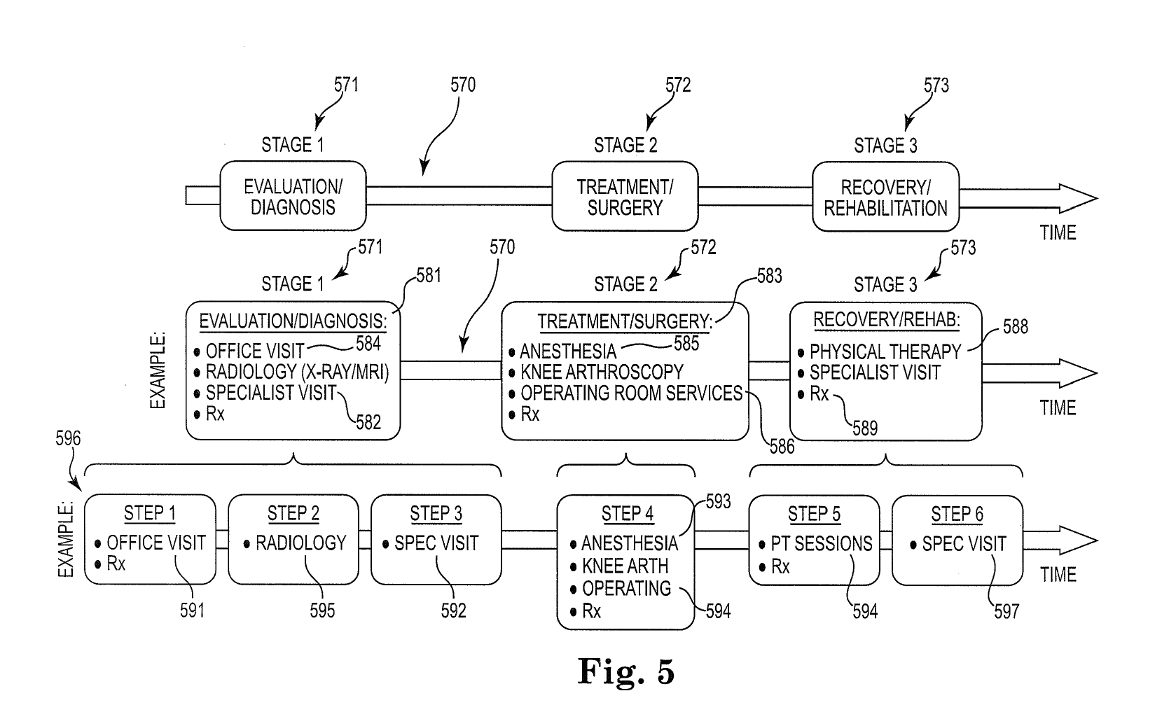

As shown in greater detail in FIG. 5, a healthcare path 570 may include a plurality of stages. For example, as shown, stages in a healthcare path may include an evaluation/diagnosis stage 571, a treatment/surgery stage 572, and a recovery/rehabilitation stage 573. It will be understood that other or additional stages may also be included in a given healthcare path 570 and are within the spirit and scope of the present disclosure. A stage may include one or more individual aspects, including procedures, treatments, etc. As shown in FIG. 5, stage 1, 571, may be the evaluation or diagnosis 581 stage. Such stage 571 may include, but is not limited to, an office visit 584 or a specialist visit 582, for example. Stage 2, 572, may be a treatment or surgery 583 stage. Such stage may include, for example, among other things, anesthesia 585, and operating room services 586. Further, stage 3, 573, may be a recovery 587 stage, which may include, for example, among other things, physical therapy 588, and a prescription 589. Of course, any given treatment path may include any number of stages, and each such stage may include a plurality of procedures or treatments.

A treatment path such as treatment path 570 shown in FIG. 5 therefore illustrates a complex system of choices that a healthcare consumer makes when deciding on a given treatment option. Further, as discussed above, for a treatment option, there may be a variety of paths to choose from, and a variety of health outcomes to consider. As such, applying the described healthcare cost estimate procedures discussed in the present disclosure to the various treatment paths, including a plurality of treatments, may give the healthcare consumer a better overall picture of the costs, benefits, and results of any given treatment path.

An alternative depiction of a healthcare path is shown at 596, wherein a healthcare path 596 is depicted as a series of steps or healthcare procedures, rather than one or more stages of healthcare. It will be understood that the terminology used herein, including “steps” and “stages” is exemplary only and is not intended to limit embodiments of the present disclosure in any way. As shown, a healthcare path 596 may include a series of steps, which may include an office visit with a prescription 591, a radiology visit 595, a specialist visit 592, anesthesia 593 and surgery 594, physical therapy 594, and a specialist visit 597, in order to complete the course of treatment from a current health state to a desired health state. As may be apparent, the present disclosure is not limited to any particular way of depicting, processing, or providing cost estimates for a healthcare path, and treatments may be grouped into any number of stages, steps, or other like representations, all of which may include one or more cost estimates as described above, in order to give the healthcare consumer the best and/or most user friendly, for example, possible representation of healthcare options so that the healthcare consumer can make the most informed healthcare choice.

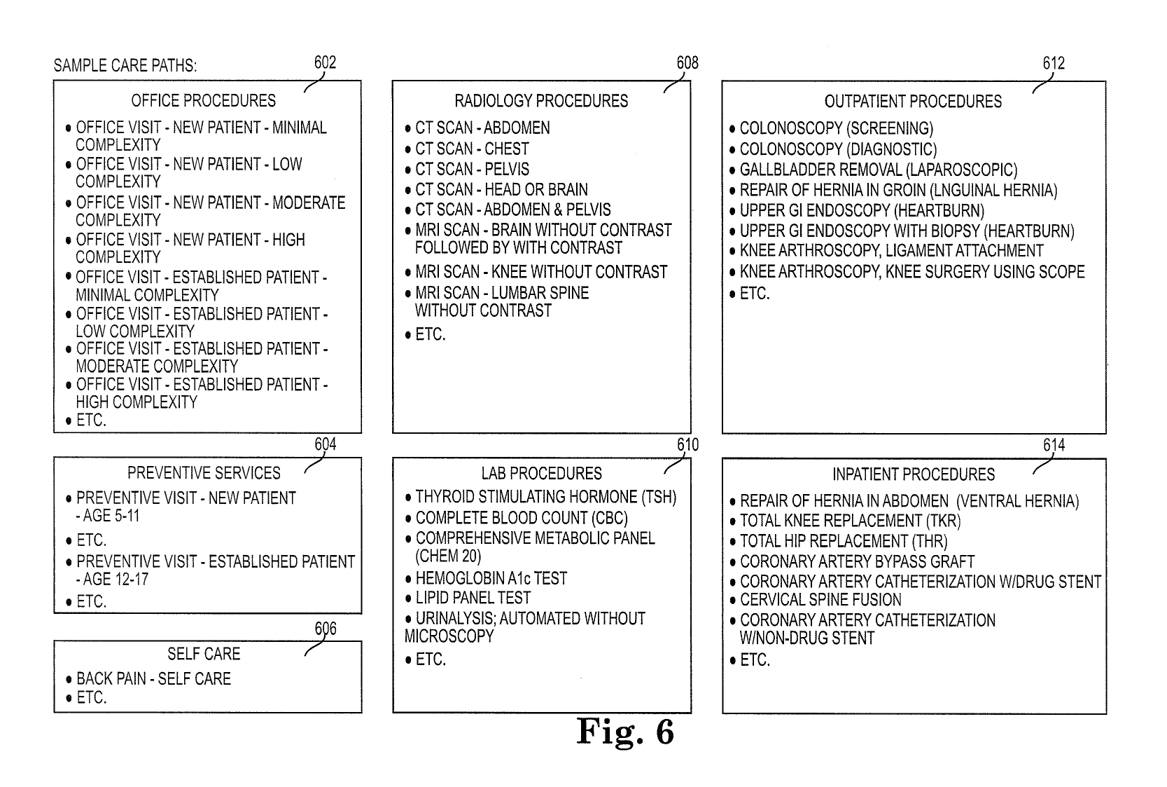

The various steps, stages, treatments, etc. that may be included in a given care path may be defined at varying levels of specificity, according to various embodiments of the present disclosure. As may be appreciated, a certain degree of specificity may be desirable so at to differentiate among meaningfully different steps, treatments, or units in a care path. FIG. 6 shows an example of the level of specificity that may be used in embodiments of the present disclosure, though it will be understood that any useful degree of specificity may be used. Seven different general illustrative categories of treatment are provided in FIG. 6: office procedures 602; preventative services 604; self-care 606; radiology procedures 608; lab procedures 610; outpatient procedures 612; and inpatient procedures 614. Provided below each of the general categories is an exemplary list of more specific procedures that may fall within the general category, and which may be used in conjunction with the systems, methods and products of the present disclosure to generate a more specific and accurate care path analysis for the consumer. For example, radiology procedures 608 may include different types of scans, for example, CT scans and MRI scans. The type of scan performed may be further broken down by the specific area or area(s) that were scanned, for example, a CT scan of the pelvis, or a CT scan of the abdomen and the pelvis.

Within any given stage, step, or other grouping within a healthcare path, each individual procedure, treatment, prescription, or the like may include an individual code. An exemplary process for and description of assigning such codes may be found in U.S. application Ser. No. 10/966,530, filed Oct. 15, 2004, now U.S. Pat. No. 8,005,687, entitled “SYSTEM, METHOD AND COMPUTER PROGRAM PRODUCT FOR ESTIMATING MEDICAL COSTS,” which was previously incorporated herein in its entirety. Accordingly, a healthcare path may include a series of one or more healthcare codes indicative of a particular procedure, treatment, prescription, etc. Of course, there may be one, two, or more different options to choose from for any given treatment, and as such, one, two, or more healthcare paths may be provided, with associated codes, for a given course of treatment (see for example FIG. 4A).

It will further be appreciated that a potentially very large number of healthcare paths may be provided to a user to choose from, at least in part because there may be a large number of healthcare facilities from which to choose, each of which may include a large number of healthcare professionals from which to choose, the selection of any one of which may result in a different healthcare path. Thus, in a further aspect of the present disclosure, the systems and methods described herein may use the cost estimate information to select a healthcare path for any given course of treatment that may minimize cost relative to other paths while maintaining high standards of healthcare, which may be generally referred to as a healthcare path optimization procedure.

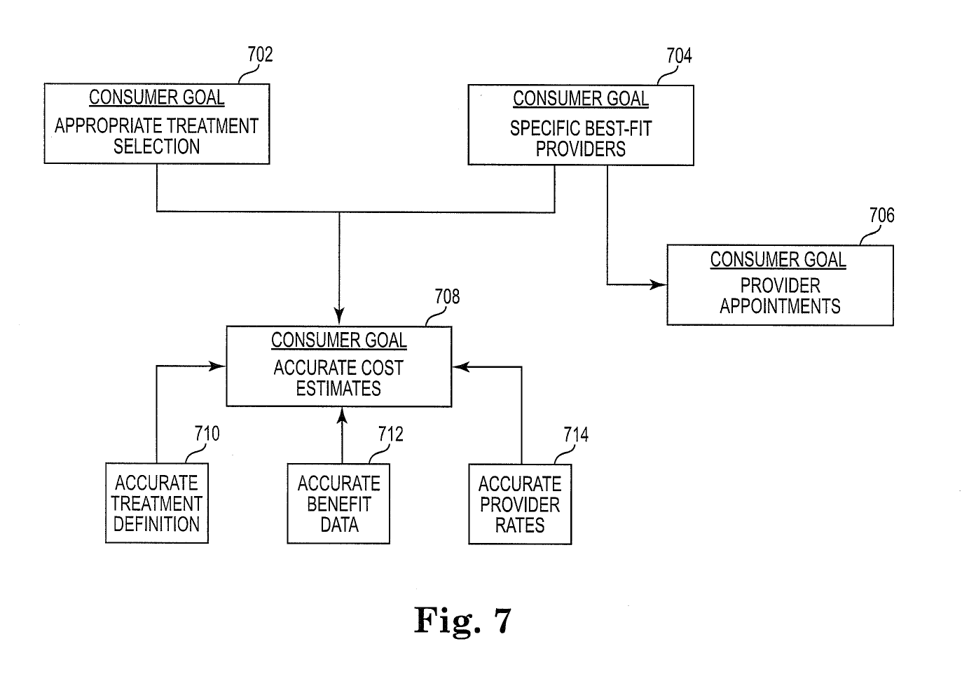

FIG. 7 shows a flow chart related to achieving consumer goals using embodiments of the present disclosure. As may be seen, a consumer may have the goal of making an appropriate choice regarding treatment selection 702. In order for embodiments of the present disclosure to facilitate that consumer goal, the system may include data related to the condition of the consumer as well as treatment options for the condition, and the system may also provide treatment decision support to the consumer, among other things. In some cases, a consumer may or may also have the goal of choosing the best provider(s) for a particular treatment 704. Embodiments of the present disclosure may include using provider demographics, provider cost, quality, and outcomes data, consumer feedback, and/or other sources of information to facilitate a consumer goal of choosing the best provider for a particular treatment 704. Along with a goal of choosing an optimum provider, a consumer may have a goal related to making provider appointments 706. Embodiments of the present disclosure may include accessing data related to provider availability, provider connectivity, and what should be done in preparation for an office visit, for example in order to facilitate meeting the consumer goal of optimizing provider appointments 706.

In addition to the goals discussed above, a consumer may have the goal of obtaining an accurate cost estimate 708 for one or more selection the consumer has made related to one or more of their treatment goals 702 and/or 704. As discussed and incorporated by reference herein, embodiments of the present disclosure make use of multiple sources of information to provide a consumer with accurate cost estimates for various treatments. In some embodiments, the systems and methods of the present disclosure may include ensuring that the treatment definition 710 identified is accurate. Ensuring the accuracy of the treatment definition 710 may involve accessing and incorporating provider-specific treatment episode data, including more treatment options, and/or other alternatives. Systems and methods of the present disclosure may also include using accurate benefit data 712 to provide accurate cost estimates 708. Accurate benefit data may be generated by reviewing and incorporating current health account data, eligibility parameters, and/or other relevant information. Further, systems and methods of the present disclosure may include using accurate provider rates 714 to help provide accurate cost estimates 708. Accurate provider rates may be obtained in some cases by consulting fee schedules, claims-based rates, geographical average rates, and/or any other relevant or desirable source.

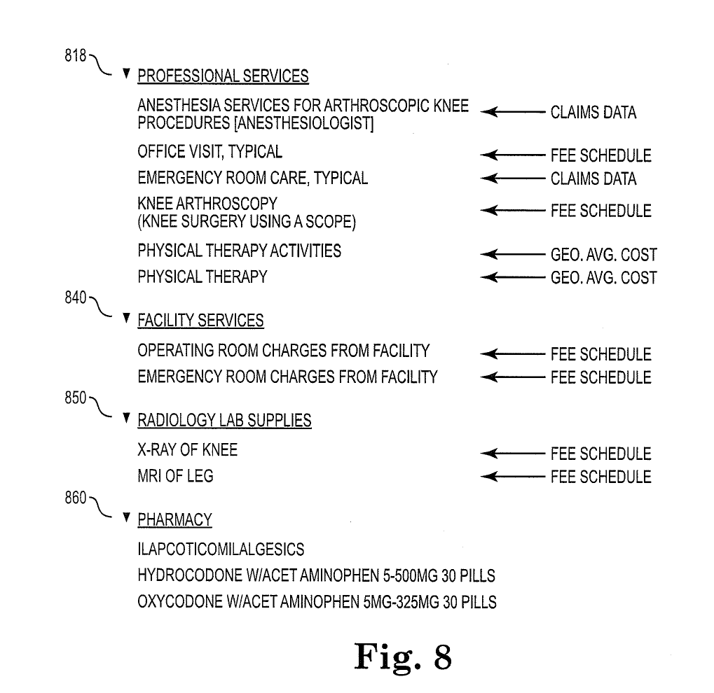

FIG. 8 provides an example of various data that may be used or used in part to provide accurate cost estimates to the consumer. For example, professional services 718 may be broken down into a variety of different therapies and/or procedures. Depending on the therapy or procedure, one or more sources of data may be consulted and used to determine an accurate cost estimate for that therapy or procedure. For example, as shown, claims data may be used as a source of data to determine the cost estimate for anesthesia services for arthroscopic knee procedures. Similarly, geographical average cost may be used as a source of data to determine the cost estimate for physical therapy activities or physical therapy. In the same manner, facility services 840, radiology/lab/supplies 850, and pharmacy services 860 may include procedures and/or treatments for which cost estimates may be provided by consulting and utilizing data from one or more available source. In some embodiments, the sources of available data may be provided largely by one source, for example, a large health care company that may have access to a significant amount of patient/member data and claims data. In other embodiments, however, the source of data may use or may also use data, for example claims data and/or member data, from other parties, companies, and/or entities, as desirable. The systems and methods of the present disclosure may be customizable to include any desirable sources of data.

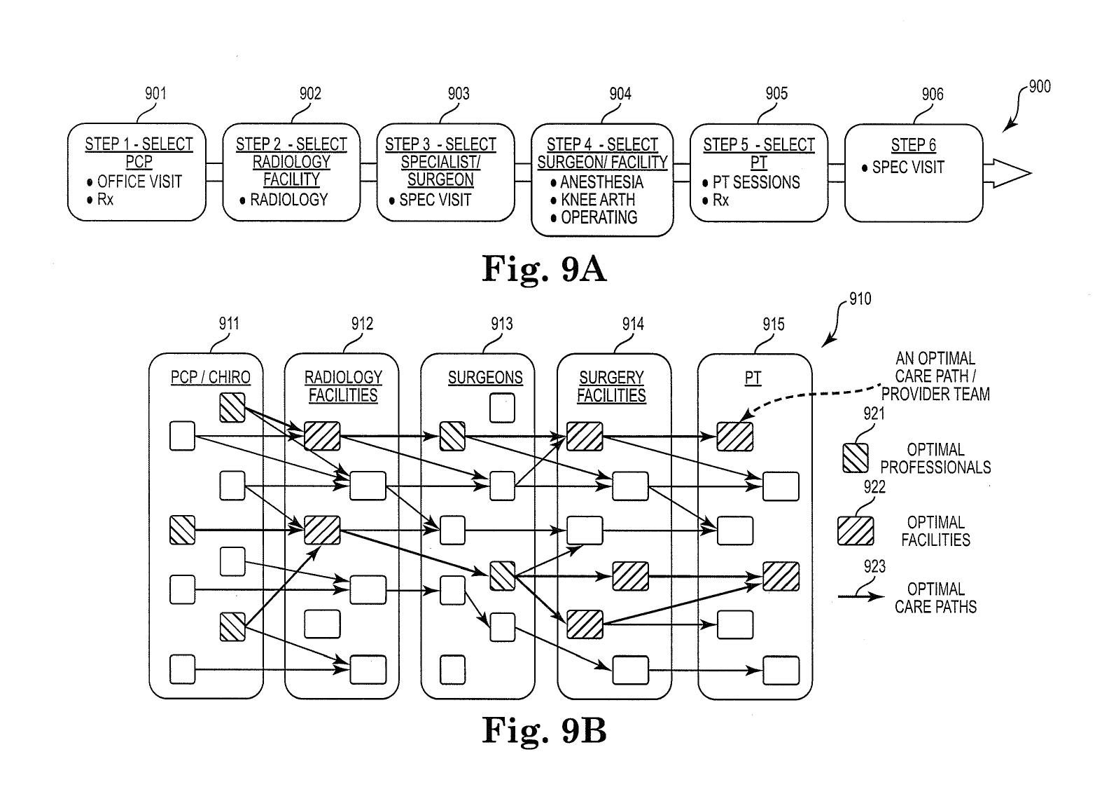

FIG. 9A depicts an example healthcare path 900, including six steps. With respect to each step, a treatment, healthcare facility, and healthcare professional may be selected from a plurality of choices. Thus, for example, at step 1, 901, a preventive care provider is selected, which may result in an office visit and/or a prescription, among other things. At step 2, 902, a radiology procedure may be selected, wherein a particular radiological facility and provider may be selected. At step 3, 903, a specialist may be required in the course of treatment, and as such, a facility and provider, for example a surgeon, may be selected. At step 4, 904, the actual surgery may take place, including a selection of surgeries, anesthesia, operating procedures, etc. At step 5, 905, post surgery procedures may occur, where a selection may be made from a variety of outpatient therapies, offered by a plurality of providers, and one or more prescriptions may be selected. Further, at step 6, 906, a follow-up specialist visit may be required, and a selection therefore may be made. As is apparent, this single healthcare path may include a wide variety of choices of treatment options, healthcare facilities, healthcare providers, and other choices, such that even figuring out the best cost and option from this single path would be prohibitive without healthcare path optimization procedures. It can thus be difficult for the average healthcare consumer to make an intelligent and fully informed decision to select the best and most cost effective treatment.

As such, FIG. 9B depicts an example healthcare path optimization procedure in connection with the healthcare path shown in FIG. 9A. Steps 901 through 905 correspond with selections 911 through 915, respectively. Based on the information made available through the systems and methods of cost estimation discussed above, professionals that have been found to perform high quality care at relatively low cost, or “optimal professionals” 921 and facilities that have been found to perform high quality care at relatively low cost, or “optimal facilities” 922 may be selected as shown. For example, at selection 911, three optimal preventive care providers are available. Further, at selection 912, two optimal radiological facilities are available. Similar availabilities are shown with respect to surgeons, surgery facilities, and physical therapy (913-915). As such, the wide variety of options is reduced down to a handful of optimal care paths 923 (bold arrows), which may be provided to the healthcare consumer for selection there among. These care paths reflect professional referral patterns and consumer usage patterns. Based on these paths, an optimal path is defined.

FIGS. 9A and 9B depict the contrast between a user selected care path (FIG. 9A), where information related thereto may simply be provided to the user, and a system optimized care path (FIG. 9B), wherein the system uses medical cost data, as discussed above, to provide the consumer with an optimum care path (as is indicated by the darker arrows in FIG. 9B). As such, where an optimization schedule is provided, the consumer may be incentivized to select the most advantageous care path, as determined by the system.

As will be appreciated, the terms “optimizing” and “optimal” and the like are indicative of relative performance. As discussed above, the cost estimation can be performed with respect to procedures, facilities, professionals, etc., where the costs incurred can be wide ranging. Thus, optimization seeks to determine one or more such procedures, facilities, and professionals that provide high-quality care as determined by outcomes, while maintaining relatively lower costs. FIG. 9B shows examples thereof.

It will be further appreciated that, in one aspect of the disclosure, consumers are incentivized or otherwise encouraged to choose optimal providers, given the available data. Such providers may be referred to as “Tier 1.” Similarly, consumers are disincentivized or otherwise discouraged from using less optimal providers, given the available data. Such providers may be referred to as “Tier 2.” As such, in one aspect, consumers are incentivized to shift their health care decisions from Tier 2 providers to Tier 1 providers. The example Tiers used herein are given for illustrative purposes only, and it will be appreciated that more or fewer aspects of a like hierarchy are included within the scope of the present disclosure.

The results of an optimization in accordance with the present disclosure may be displayed to the healthcare consumer in any of a variety of methods. For example, a healthcare path or series of paths as shown for example in FIGS. 4A and 4B may be presented to the consumer in electronic form, for example, using a computer connected to the Internet or other network, wherein the information may be provided to the consumer using an Internet Web address, email, or other electronic form. Alternatively, the results of an optimization may be provided to the consumer in physical form, such as on paper and delivered through the mail. Other known forms of depiction and other methods of delivery to the healthcare consumer are considered to be within the scope of this disclosure.

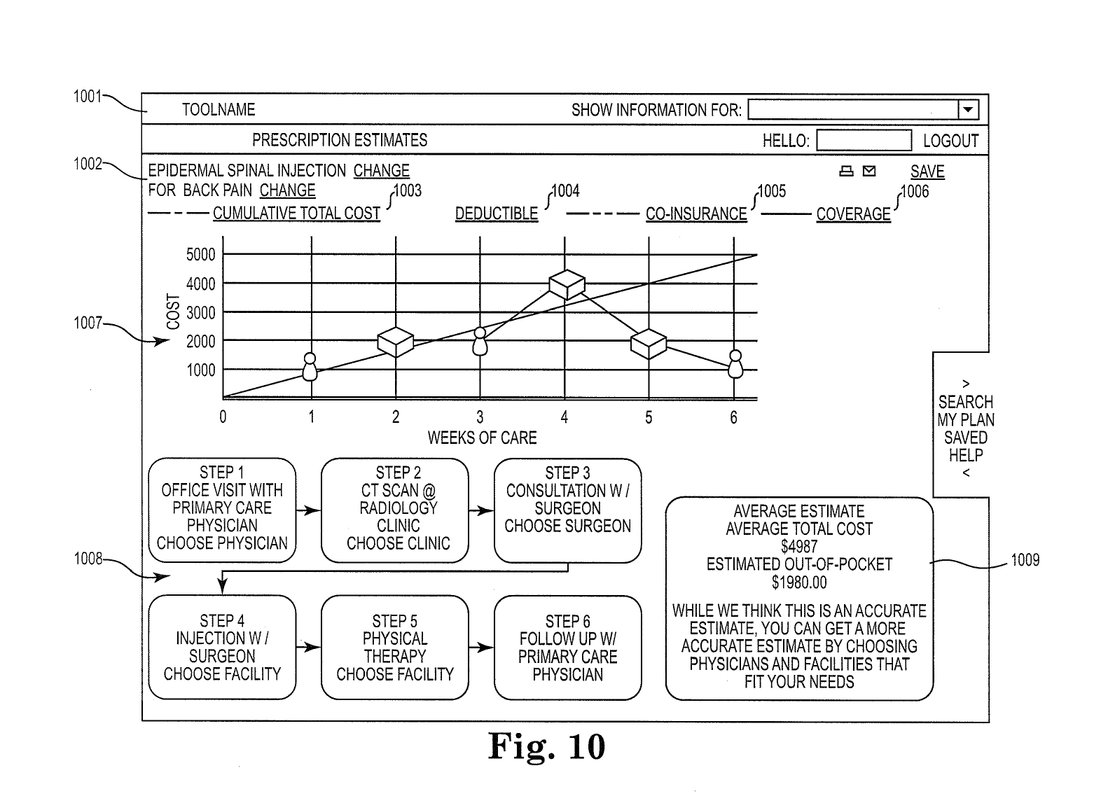

An example optimization result is depicted, in one embodiment, in FIG. 10, for provision to the healthcare consumer. The depiction may include an information bar 1001, which may include the name of the depiction, the consumer name, and an estimate designation. As further shown in FIG. 10, the course of treatment 1002 is depicted for the consumer's reference. With regard to the cost estimates of the particular healthcare path shown, the estimate may be provided in graphical form 1007, and may include an estimate of costs that are deductible 1004, co-insurance 1005, and/or covered 1006, and may also include a cumulative total cost 1003 thereof. The estimate of costs may be provided over the time range of treatments, which may include a number of weeks of care, and when such costs may be incurred. The depiction, as shown in FIG. 10, may also include a stepwise illustration of the healthcare path, including for example steps 1 through 6. This may correspond to the depiction as shown in, for example, FIG. 5. Further, a summary of the cost estimate may be provided, as shown at block 1009.

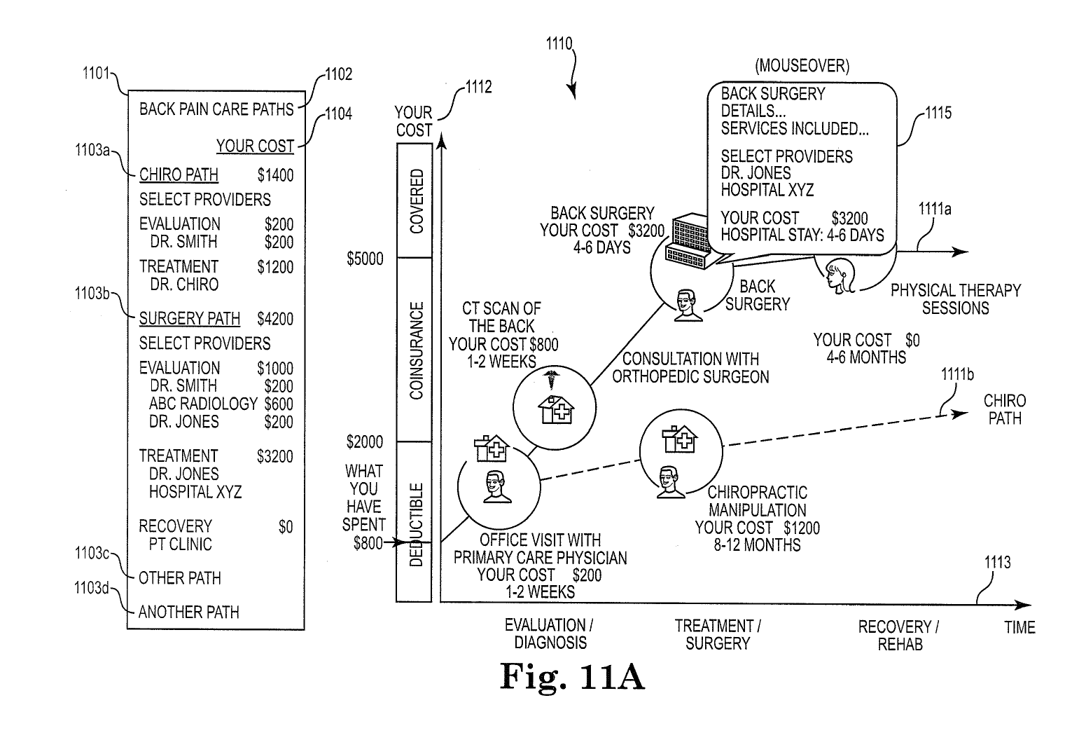

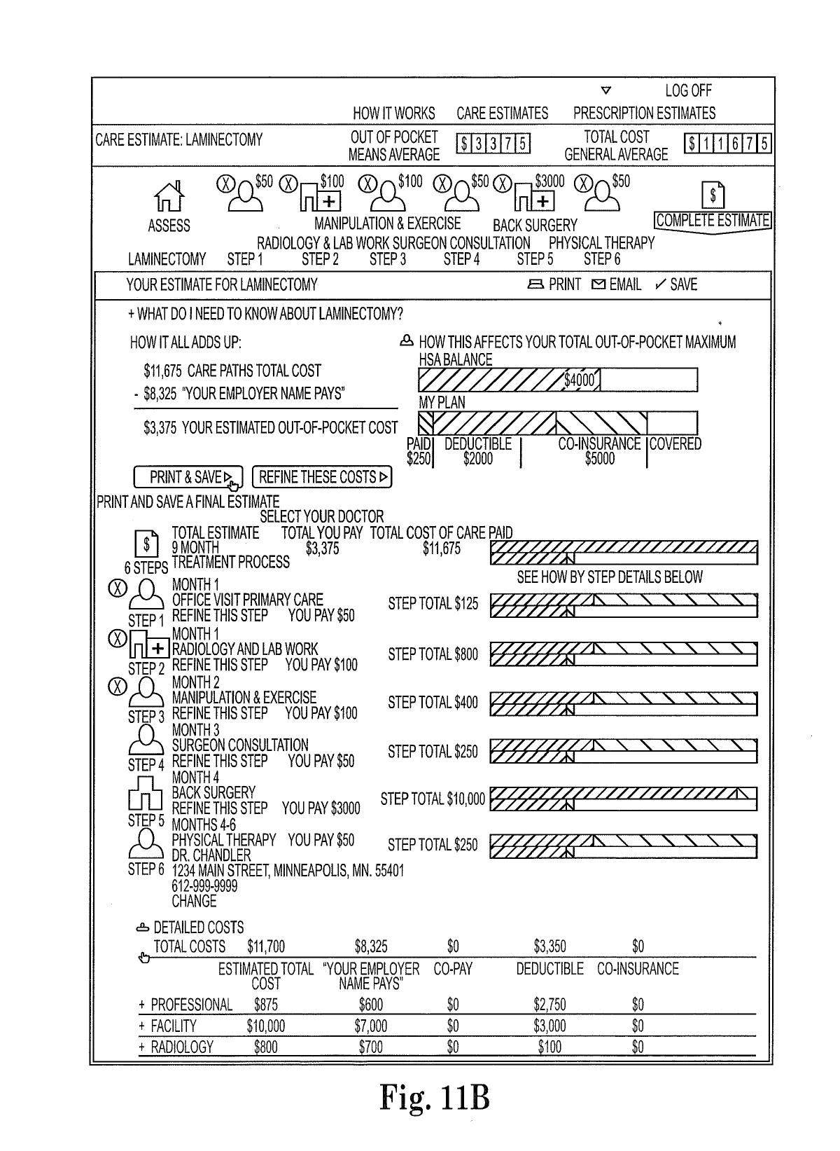

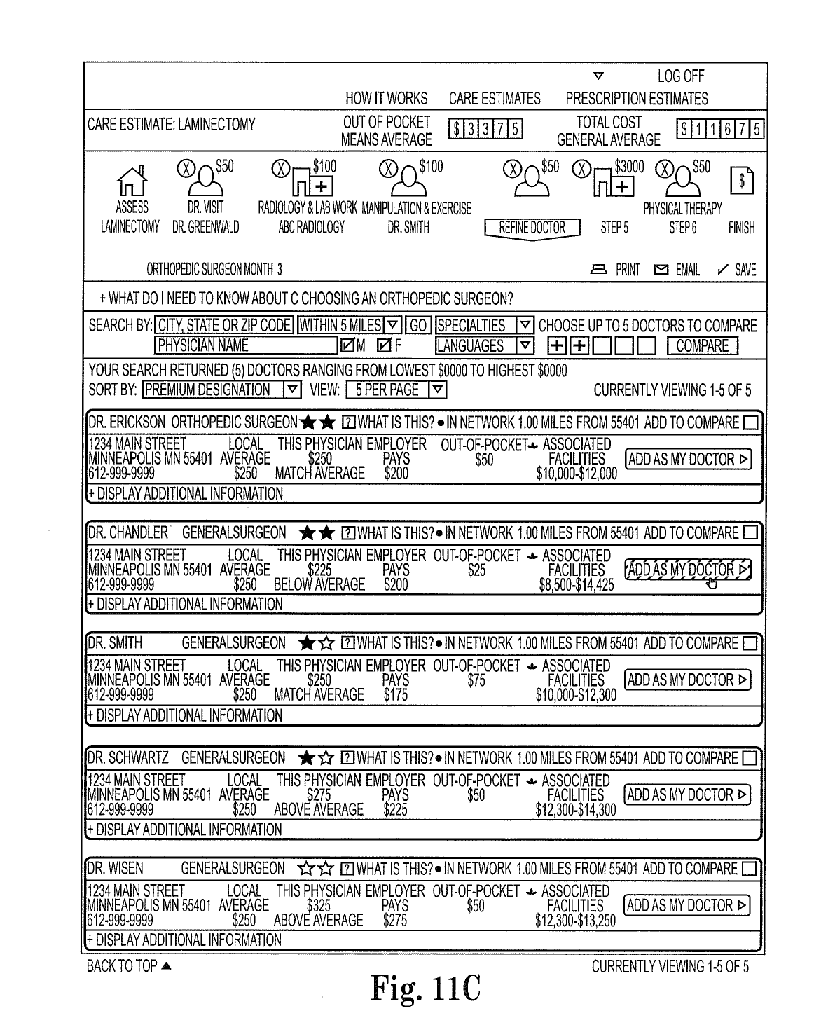

In another embodiment, an alternative depiction of a healthcare path may be provided, as shown in FIG. 11A. For example, as shown in FIG. 11A, a block 1101 of possible healthcare paths may be depicted, along with their associated costs. Shown in block 1101 are healthcare paths 1103a through 1103d. Path 1103a is a chiropractic path, which may include evaluation and treatment by one or more providers. Path 1103b is a surgery path, which may include evaluation, treatment, and recovery time. Paths 1103c and 1103d are shown for illustration, but left blank for ease of illustration. With respect to each path, a total cost of treatment is shown, 1104. As is apparent, the chiropractic path 1103a, at $1400, is considerably less expensive than the surgery path 1103b, at $4200. For the purposes of further illustration, a chart 1110 is further provided to the healthcare consumer in order to depict certain aspects of each healthcare path available. For example, chart 1110 may include a representation of costs 1112, which may include those that are deductible, co-insurance, and/or covered. The chart may also include a timeline for each path, including evaluation and diagnosis, treatment and surgery, and/or recovery and rehab time. Each path may be shown as a series of steps over time, with associated costs. As shown in FIG. 11A, path 1111a is the surgery path and includes the office visit, consultation, surgery, and physical therapy, with associated costs. Alternatively, path 1111b shows the chiropractic path, including an office visit, and a chiropractic procedure, including the associated costs and timeline. In some embodiments, the healthcare consumer may be able to “mouse over” a particular step in the chart, and gain further information about the details of the step, the services included, the providers available, the facilities available, the cost, the time for the procedure, and/or other information. FIG. 11B shows an example of how a user of the products, methods and systems of the present disclosure may be provided information related to a particular care path. Similarly FIG. 11C shows an example of how a user of the products, methods and systems of the present disclosure may be provided information related to selecting a particular provider.

It will be appreciated that the healthcare path and cost estimates shown in FIGS. 10 and 11A and 11B are merely examples, and such depictions may include more or fewer paths, more or fewer treatment options, and other information associated with the treatment of a medical condition as has generally been described herein.

In a further aspect of the present disclosure, it will be appreciated that there is a large number of courses of treatment for medical conditions that are routinely provided to healthcare consumers. Such procedures may be referred to as “high-volume” or “commodity” procedures, wherein there are a large number of healthcare providers and healthcare facilities providing such services. As described above with respect to cost estimation, the range of costs for such common procedures can vary widely. As such, it may be desirable to establish a “preferred,” or series of preferred, healthcare paths from which to choose for such common procedures. For example, a common procedure that is routinely done is an appendectomy. The procedures for the treatment of a ruptured appendix are and have been well known for years, and is a routine surgery performed by most hospitals and by most general practice surgeons. As such, when a patient requires this type of treatment, it may be desirable to have a preferred healthcare path set forth for the consumer to choose. In this manner, the common procedures and healthcare treatments that healthcare consumers are most likely to request will be readily available to the healthcare consumer without the need to perform new cost estimation computations and optimizations each time such inquiry is made.

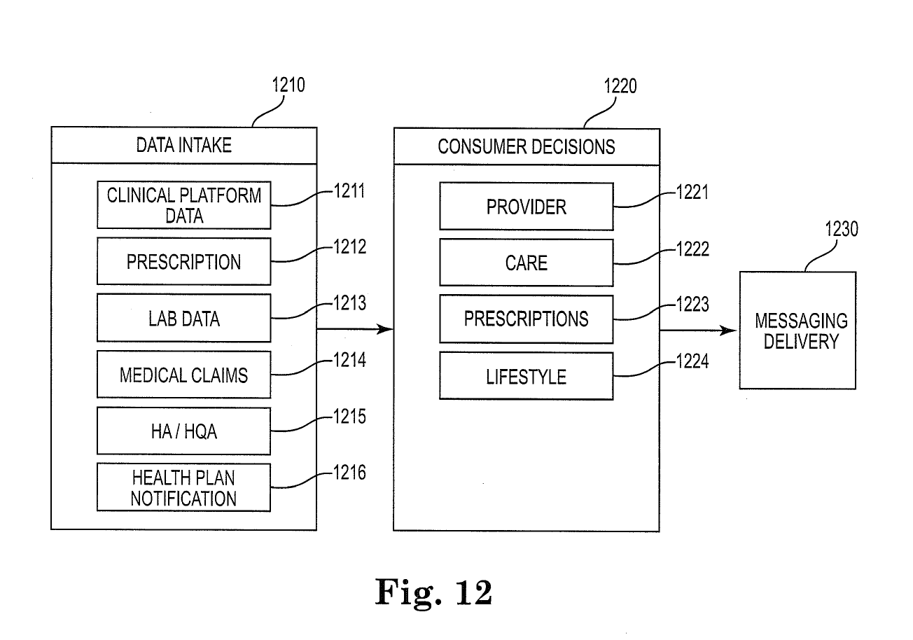

In a further aspect of the present disclosure, FIG. 12 illustrates an embodiment of an electronic advice module. The electronic advice module may be provided so as to provide consumers with advice about various aspects of their medical care, personal health, and overall well-being. As shown in FIG. 12, a data intake component 1210 receives electronic data, including clinical platform data 1211, prescription data, 1212, lab data 1213, medical claims data 1214, health assessment/health quality assessment data, and health plan notification data regarding a consumer. This information is segregated into various health-related aspects as shown at the consumer decisions component 1220, which may include provider aspects 1221, care aspects 1222, prescription aspects 1223, and lifestyle aspects 1224. This information may be used to provide consumers with relevant information through a messaging system 1230. Accordingly, FIG. 12 shows how the consumer may select the right provider, right care path, right prescriptions, and right lifestyle. The information allows the system to suggest to the consumer a more cost effective option without sacrificing quality. For instance, if a user is using a high cost provider, the system may suggest other providers from which the consumer may select a more cost effective option with similar quality and/or similar outcome.

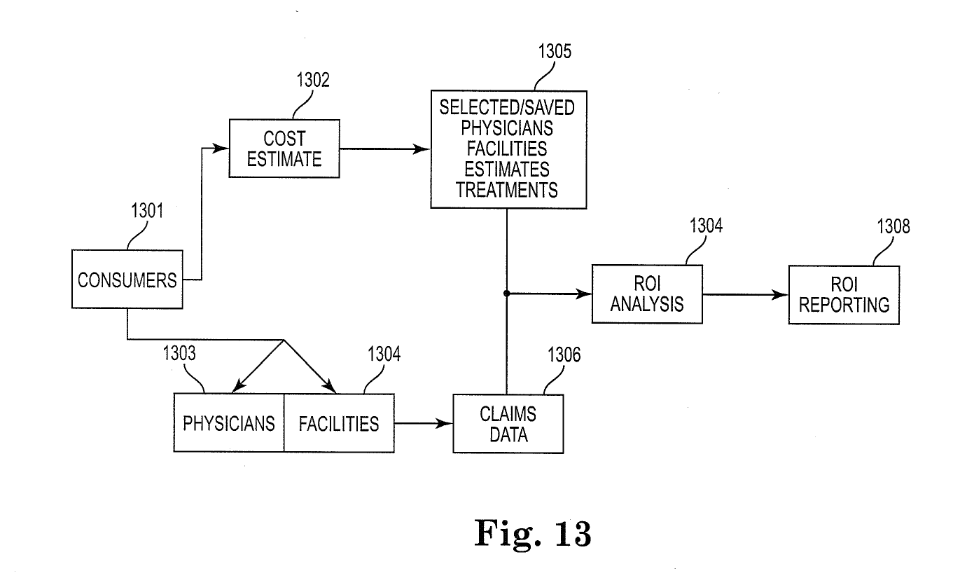

In a further aspect of the present disclosure, FIG. 13 illustrates an embodiment of a return on investment (ROI) measurement and tracking module. Consumer data 1301 is received into a cost estimator (as described above) 1302. Selected/saved data regarding physicians, facilities, estimates, and treatments 1305 may be used as well. The consumers choose physicians 1303 and facilities 1304, and a medical cost is incurred, shown in the form of claims data 1306. Medical cost data resulting from 1302/1305 may be compared against actual data from the claims 1306. An ROI analysis is performed 1307, for example, by comparing the actual cost to a baseline cost from the data 1302/1305. Various reports 1308 may be generated from an ROI analysis 1307, as will be known to those of ordinary skill in the art.

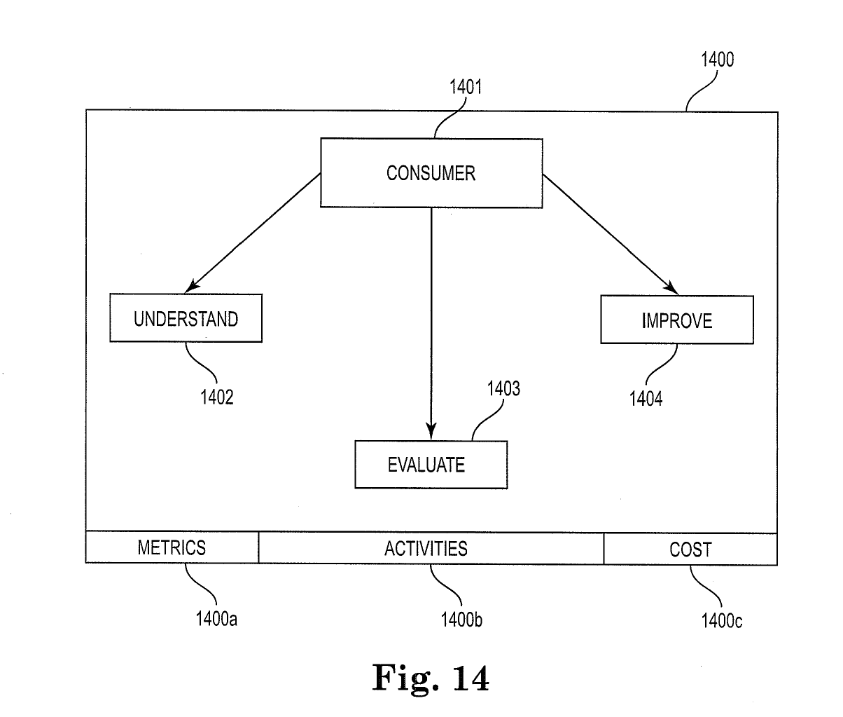

In a further aspect of the present disclosure shown in FIG. 14, a consumer report card 1400 may be provided, concerning consumer health metrics 1400a, consumer health activity metrics 1400b, and consumer medical cost metrics 1400c. The report card 1400 may be provided to consumers 1401 based on medical claims information processed regarding the consumer, and based on personal information supplied by the consumer, for example, through a health assessment. A report card 1400 may include information to help the consumer “understand” 1402 the health care information that has been provided to them. A report card 1400 may include information to help the consumer “evaluate” 1403 the health care information that has been provided to them. A report card 1400 may include information to help the consumer “improve” 1404 a medical condition. Health care information to be provided may result from a recent care episode, a period recurring evaluation, or health assessment information, for example.

The benefits of the presently disclosed system and method, including the healthcare path approach coupled with cost estimation, may include a more clear, concise, and easy to understand depiction of the healthcare options that are available to consumers for the treatment of any given medical condition. Using the systems and methods described herein, the consumer may be able to enter a medical condition, and receive one or more optional healthcare paths that have been optimized for the healthcare consumer based on the cost estimation and path optimization techniques described herein. Further, the system and methods described herein may provide the healthcare treatment options to the consumer in an easy-to-read and understand format, such as a graphical format or chart display showing the length of time for the total course of treatment, the associated costs, and/or other information. Further, for common procedures, one or more preferred healthcare paths may be provided to the consumer for easier selection. As such, the complex and fragmented world of healthcare options is brought into a more manageable form for the consumer to make the best healthcare decision possible.

In yet further aspects of the present disclosure, computer-implemented systems and methods and computer program products may be configured to facilitate consumer healthcare decisions by providing a consumer with customized healthcare path recommendations that may be selected and shaped in response to healthcare information specific to the consumer. As a consumer engages with the systems of the present disclosure, their involvement may be tracked and used in connection with the consumer's demographics and preferences to deliver meaningful healthcare path recommendations that are targeted directly to the consumer's healthcare needs.

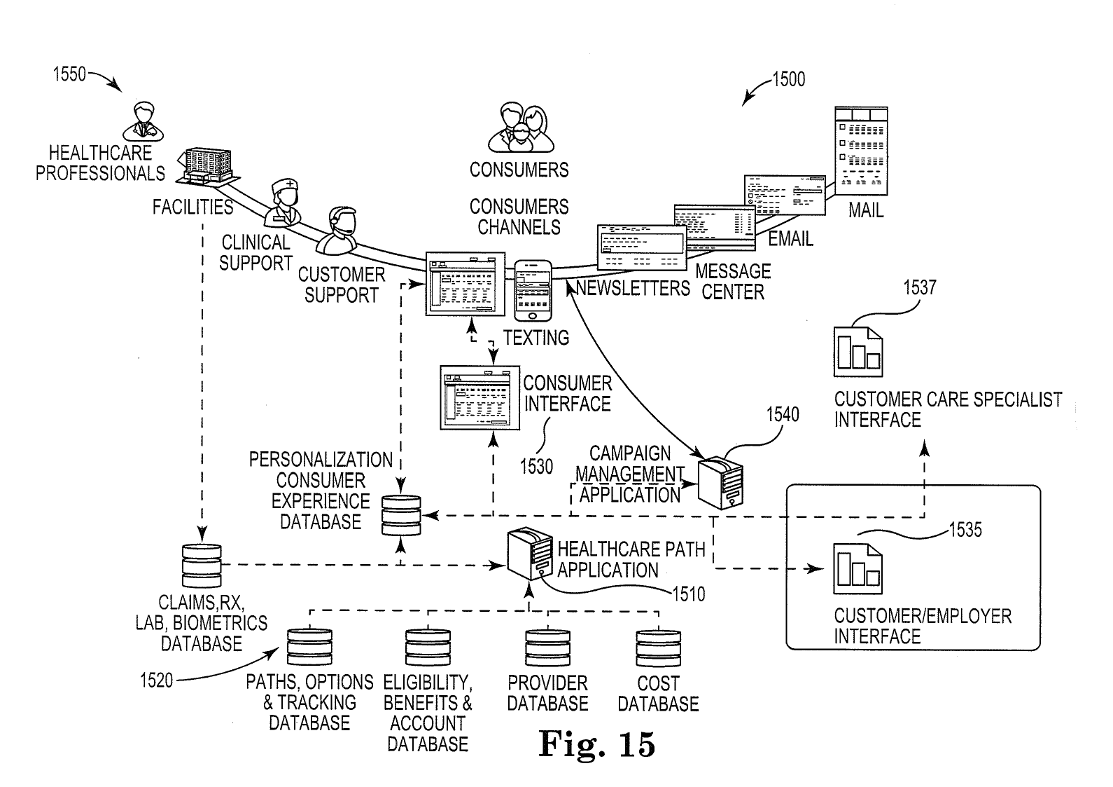

FIG. 15 illustrates a block diagram of a consumer health management system 1500 configured to generate customized healthcare path recommendations according to the present disclosure. The system 1500 may be accessible to users over a network and may be communicatively coupled to, or integrated with, the healthcare path system 100 of FIG. 1. In FIG. 15, the system 1500 includes a healthcare path application 1510 communicatively coupled to databases 1520 storing healthcare information, a consumer interface 1530, a customer/employer interface 1535, a consumer care specialist interface 1537, a campaign management application 1540 and delivery channels 1550. The system may be utilized by consumers, such as insured individuals holding a health plan and a family member covered under these health plans; customers, including individuals providing services to the insureds, such as health insurance company representatives; employers, such as those that employ the holder of the insurance policy; and consumer care specialists such as healthcare professionals, clinical support representatives, customer support representatives. According to the present disclosure, consumers, customers and employers may be users of and may access the consumer health management system 1500 to provide an integrated user experience across consumer-preferred delivery channels, both inbound/self-service and proactive outbound/outreach channels. In some aspects, the system 1500 may be controlled or periodically updated by a medical insurance company.

The consumer healthcare path application 1510 of the system 1500 may be configured to access the databases 1520 to query the information stored therein and generate healthcare path recommendations tailored to the consumer. These recommendations may include a variety of treatment options for addressing a consumer's health including medical symptoms and conditions. Treatment options may include formal medical services as well as self-care options. In some implementations, the healthcare path application 1510 of system 1500 may be integrated with the healthcare path navigator 64 of the system 100.

The databases 1520 accessed by the healthcare path application 1510 may store information used for generating the consumer's healthcare path recommendations and cost information related to the consumer following the recommendations. This stored information may include healthcare paths, treatment options and guidance associated with the recommendations, and data related to tracking a consumer's participation in their selected healthcare path such as medical outcomes. In addition, the stored information may be personalized information related to the consumer that may be used to customize the recommendations, and may include consumer-reported information (e.g., information related to the consumer that is reported by a user of the system), as well as content used to elicit entry of consumer-reported information into the system (e.g., search templates for healthcare services, providers and benefits). Such personalized information may be connected to the consumer's health, gender, age, his/her preferences on receiving treatment, as well as consumer interactions with the system including consumer navigation, searches and selections entered into the system 1500. Other information that may be stored by the databases 1520 includes the consumer's health plan (e.g., eligibility, benefits, and health account information); consumer claims, prescriptions, labs, and biometrics; and information for providers. Further, the stored information may be related to costs in associated with engaging in the consumer's healthcare paths, which may be connected to the consumer's health plan. Current fee schedules for medical services (e.g., providers and associated procedures), historical and/or average costs may also be stored for use in generating costs, cost savings estimates and realized cost savings associated with following the paths. In addition, the databases 1520 may be configured to store medical data associated with the categories of data 304-314 provided by the data sources 302 of FIG. 3, and may be used in connection with generating healthcare paths and calculating cost information. Although FIG. 15 depicts multiple databases 1520 configured to store information associated with generating healthcare paths for the consumer, a single database may be configured to store such information. While the information stored by the databases 1520 is described in the context of a consumer, the information stored by the databases may be for consumers across a medical network and may be utilized in generating the healthcare path recommendations for any of the consumers across the network.

The consumer user interface 1530, the customer/employer interface 1535 and the consumer care specialist interface 1537 of the system 1500 may be configured as online portals or websites with user interfaces that allow users to access the healthcare path application 1510 of the consumer health management system 1500. Through utilization of the interfaces, health-related searches and personalized information may be entered. In addition, user navigation, searches, and selections may be logged for use in generating customized healthcare path recommendations. The consumer interface 1530 may enable consumers to access the system, while the customer/employer interface 1535 may enable a customer/employer to access the system 1500 on the consumer's behalf and provide the consumer with the consumer's customized healthcare path recommendations. In addition, the customer/employer interface 1535 may provide the user with utilization and cost savings information for a consumer population such as an employee group. Further, logging consumer utilization may be conducted in real time as a consumer care specialist utilizes the consumer care specialist interface 1537 to observe the consumer's interactions and engage with the consumer during the consumer's experience with the system 1500. The interfaces may be configured as a unified platform that may allow a user to view, search for and select treatment options, including healthcare path options; view cost estimates; schedule appointments; order medical supplies; interact with consumer care specialists where the user is a consumer; and view and select health plans.

The campaign management application 1540 of the consumer health management system 1500 may control delivery of customized healthcare path recommendations, cost savings information and other communications related to the consumer managing their health. The campaign management application 1540 may generate and deliver personalized content to the consumer based on the information stored in the databases 1520, including consumer preferences on receiving communications from the campaign management application 1540. The recommendations or other communications delivered may be targeted directly to the consumer and synchronized across one or more of the communication channels 1550 of the system 1500, including via consumer care specialists; providers; consumer portals; text messaging; newsletters; message centers; email; mail and newsletters. In addition, once the system confirms the consumer has engaged in an activity related to the consumer's healthcare path recommendations, the campaign management application 1540 may notify the consumer of further healthcare path recommendations, related cost savings opportunities, and realized cost savings via the communication channels 1550. Further, the campaign management application 1540 may be configured as a platform to permit interaction with the system 1500 in a manner that helps provide motivation for, track compliance with and outcomes of healthcare path implementation activity. The stored compliance with and outcome information collected during implementation of the healthcare path, may provide a basis for group study of efficacy of such paths.

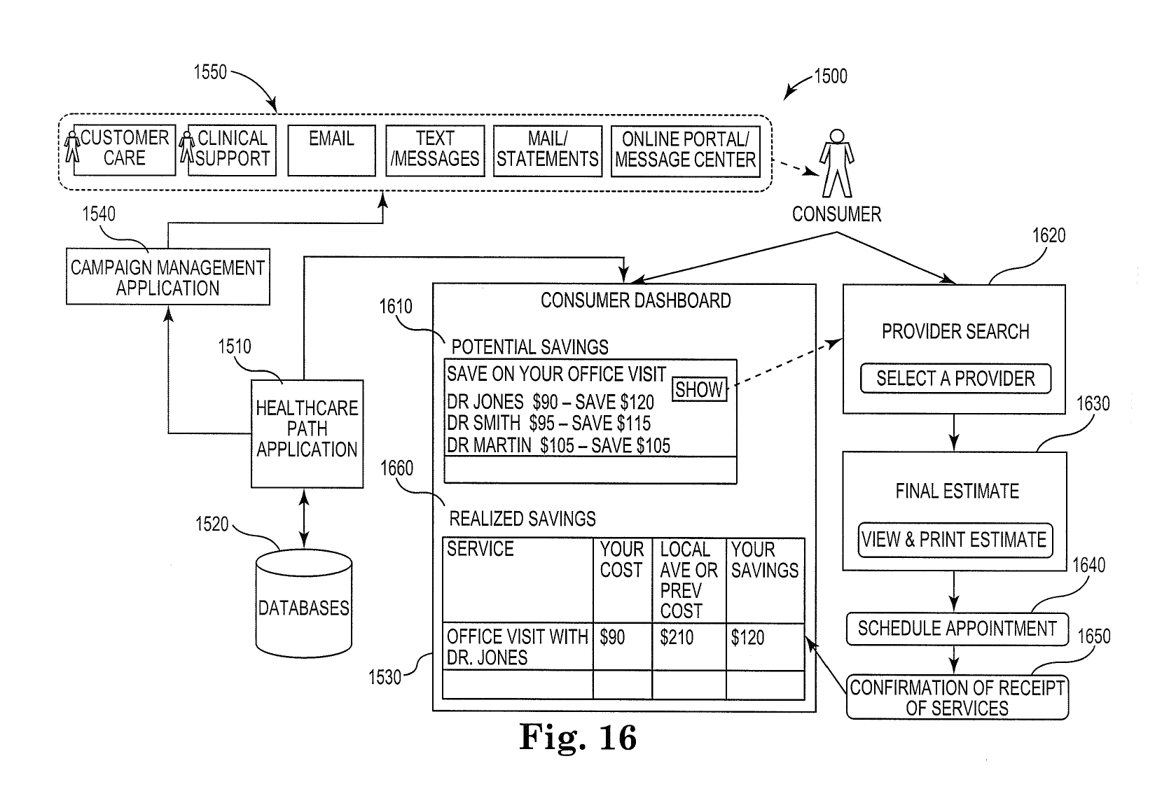

FIG. 16 illustrates an example of a block diagram of an implementation of the consumer health management system 1500 in which a consumer may review and make selections in connection with their customized healthcare path recommendations. Although FIG. 16 addresses a consumer's use of the system 1500, other users including customers and employers may use the system 1500 to facilitate the consumer's selection of recommendations.

Using the system 1500, a consumer may receive customized healthcare path recommendations generated by the healthcare path application 1510 based on the information stored by the databases 1520, which may include both historical information and real time information entered by a user of the system 1500. The consumer may review their recommendations and enter selections for treatment options to address their medical condition via the consumer interface 1530. For example, the consumer interface 1530 may provide a list of customized recommendations including treatment options such as medical services and additional details including associated cost savings information. In FIG. 16, the treatment options include a list of providers and associated medical service cost savings 1610 (e.g., estimated cost savings for providers, healthcare paths, procedures and/or prescriptions based on market averages). The listing may include several options offering the same level or varying levels of care in connection with healthcare path recommendations, and may be customized according to the consumer's personalized information.

The consumer may select one or more of the recommendations from the consumer interface 1530 or search for and select other recommendations. In addition or alternatively, the consumer may search for other recommended providers using the provider search functionality 1620. Based on the consumer selections, cost estimates (see e.g., FIG. 11B) may be viewed and printed using the view and print estimate functionality 1630. In some implementations, where a healthcare path is selected with multiple steps, the consumer may view and print estimates for one or more of the steps. In addition, using the appointment scheduling functionality 1640, appointments may be scheduled, for example, that involve following a treatment option associated with the consumer's healthcare path recommendations.

Upon confirming the consumer received services related to treatment options 1650, such as by confirming the consumer engaged in activities related to the healthcare path recommendations (e.g., through detecting medical claims or self-reporting), the healthcare path application 1510 may use claim and/or cost information connected to the treatment options to calculate realized cost savings 1660. The savings may be viewed, for example, by accessing the consumer interface 1530. In addition or alternatively, the campaign management application 1540 may transmit the realized cost savings and consumer health-related content to the consumer using consumer-preferred communication channels.

Accordingly, the system 1500 may be used to proactively communicate the consumer's healthcare path guidance recommendations and associated cost savings and follow-up with the consumer in order to communicate the impact the consumer's choices have on their health and health costs. This may provide transparency to the consumer related to their medical services and associated costs that may not otherwise be available.

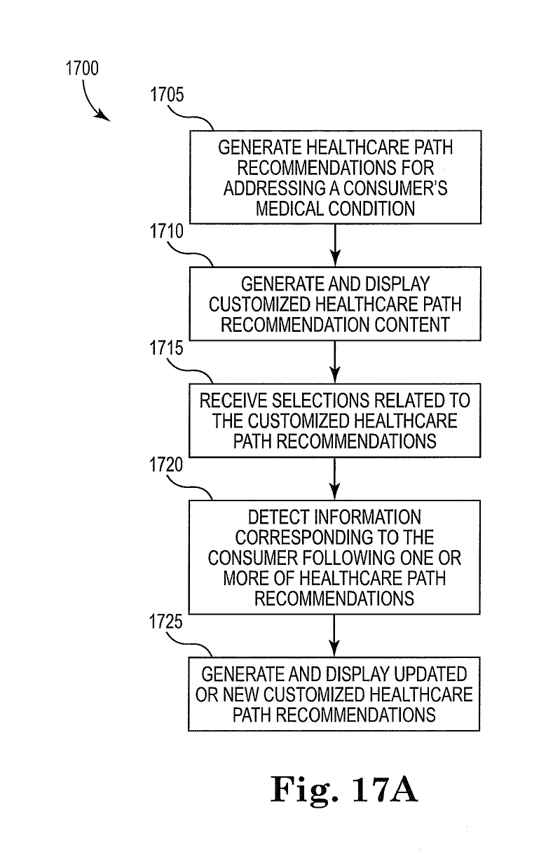

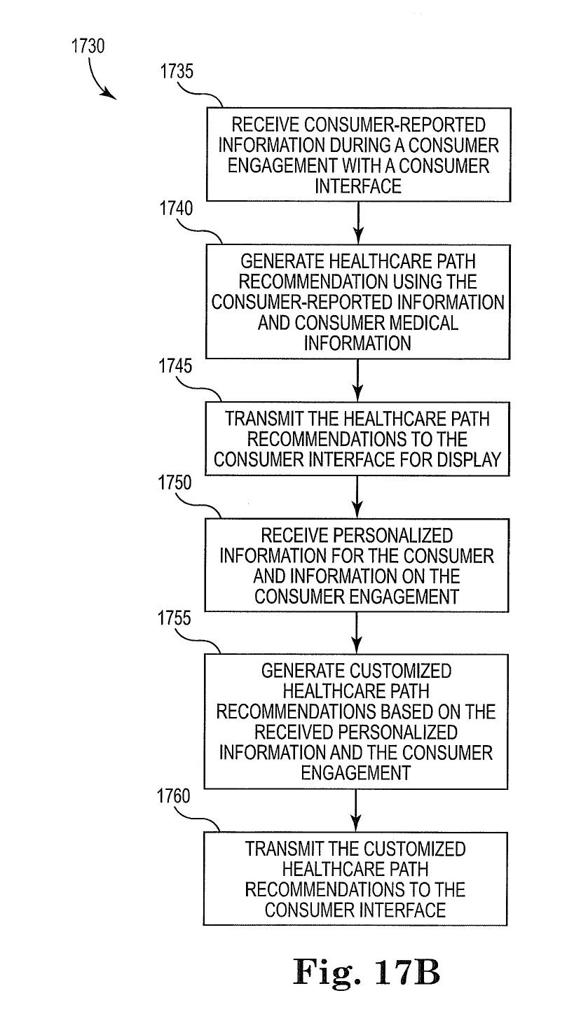

In some aspects, the system 1500 may be configured to perform the method 1700 of FIG. 17A in which consumer healthcare decisions are facilitated through providing customized healthcare path recommendations for addressing a consumer's medical condition. For example, the method 1700 may be implemented in software modules executed by a processor configured to perform the steps of method 1700.

Generate Consumer Healthcare Path Guidance Recommendations:

According to method 1700, the healthcare path application 1510 may analyze medical information applicable to the consumer to identify a consumer medical condition (e.g., a medical condition that the consumer is experiencing or is predicted to experience) and generate 1705 healthcare path recommendations for the consumer to address their medical condition. For example, consumer information may be analyzed in relation to historical medical information, and healthcare path recommendations for improving the consumer's well-being may be generated.

The consumer information may include a variety of health-related information relevant to the consumer addressing their health discussed above in connection with the information stored in the databases 1520. This information may be historical information residing in the databases 1520 over a period of time, may be information entering the system 1500 in real time, or both. For real time information entering the system 1500, this may be detected in connection with the consumer or other user of the system 1500 engaging with an appropriate user interface. Real time information may include consumer-reported information entered by users of the system 1500 and may relate to answering questions about the consumer's symptoms, conditions, and medical treatments, and the responses may be pre-defined (e.g., based on a list of answer selections) or may be free text input (e.g., open-ended answers).

The consumer information may be analyzed in relation to historical medical information, such as evidence-based medicine, literature, studies as well as other information useful in identifying treatment options for addressing the consumer's health condition. Based on the analysis, the system may identify a group of procedures commonly used to address the consumer's health condition and generate 1705 healthcare path recommendations for improving the consumer's well-being.

The healthcare path recommendations may include healthcare paths with treatment options for addressing the consumer's medical condition (e.g., current or predicted). These treatment options may include medical services and self-care options. In addition, the healthcare path recommendations generated may include explanations or summaries about the treatment options; the symptoms and conditions typical to those electing to receive such treatment options; costs; quality of recommendations (e.g., resource ratings); duration; benefits and risks of receiving the treatment options derived from evidence-based medicine; and where the option falls within a consumer's healthcare path.

With respect to treatment options connected to medical services, these may be administered by providers and may include related procedures.

Self-care treatment options may include behavioral modifications such as diet and exercise, watchful waiting, other non-medical approaches to addressing healthcare issues or approaches that involve the consumer taking a more conservative or alternative approach to their healthcare with no or limited professional medical intervention.

In some examples of use, the recommendations and related treatment options generated may be an initial set of recommendations for addressing a consumer's medical condition. For example, the analyzed consumer medical information used to generate this initial set may include preliminary information related to the consumer's health, such as one or more of a consumer's symptoms, conditions, duration of the condition, past procedures or medical outcomes. In addition, other consumer information stored in the databases 1520 may be used to generate the initial set of recommendations.

In some implementations, the healthcare path recommendations may be narrowed to include specific treatment options supported by the consumer's health plan. This may involve analyzing the consumer's health plan (e.g., eligibility, benefits, banking), past consumer cost information (e.g., deductibles and coinsurance), provider information (e.g., provider network and provider information), cost information (e.g., provider-specific costs and market averages) and other information stored by the databases 1520 to provide a set of recommendations that align with the consumer's health plan.

In some implementations, the healthcare path recommendations may be based on analyzing historical medical claims for the consumer and identifying gaps in care. For example, the consumer's medical records may be outdated indicating that the consumer is due for an annual check-up.

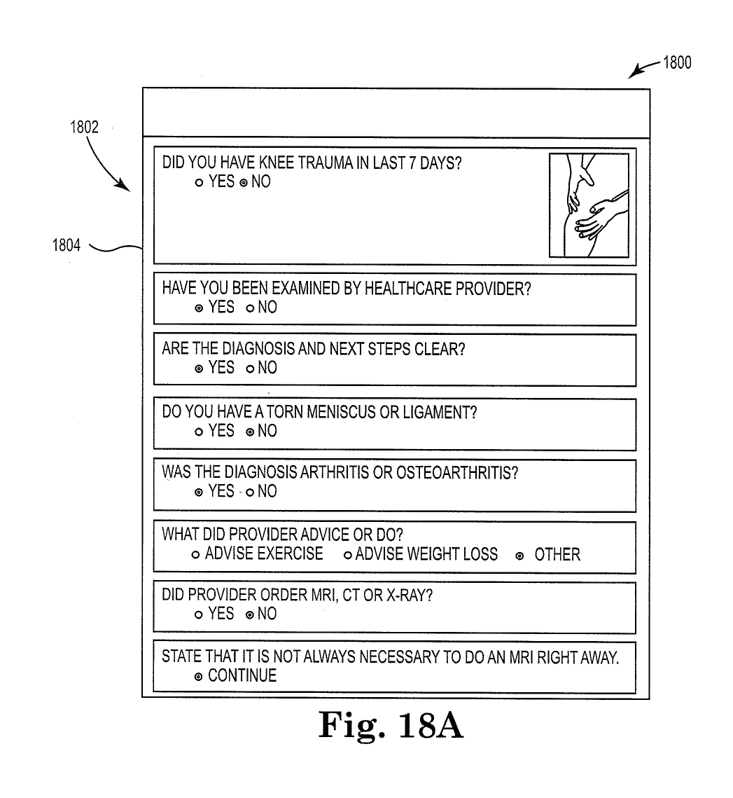

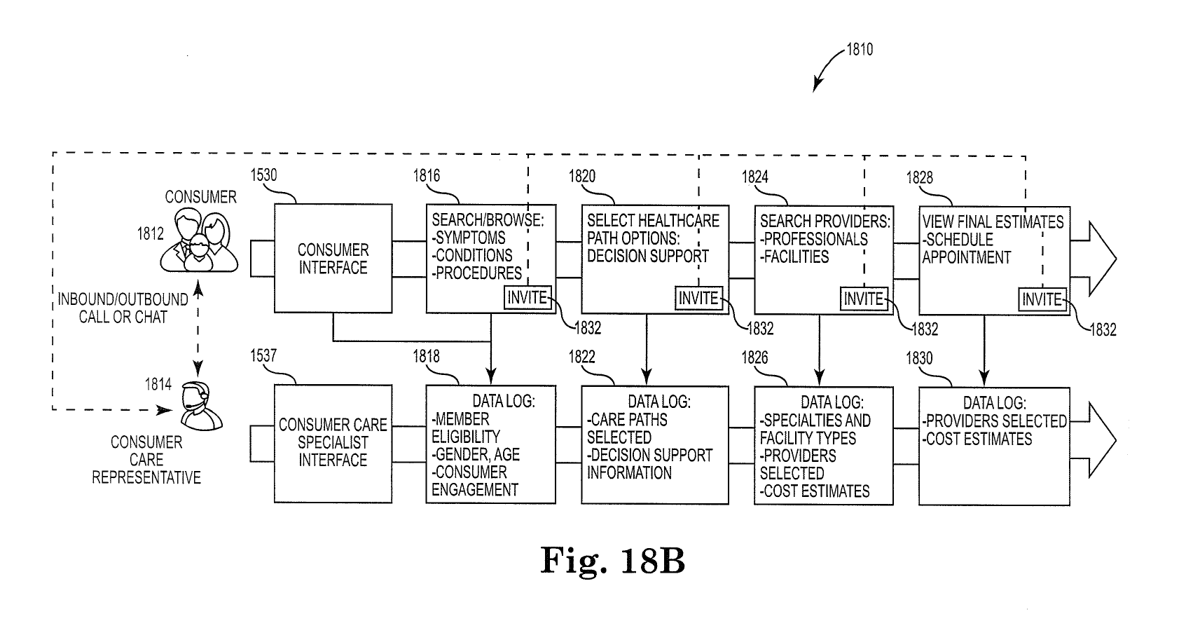

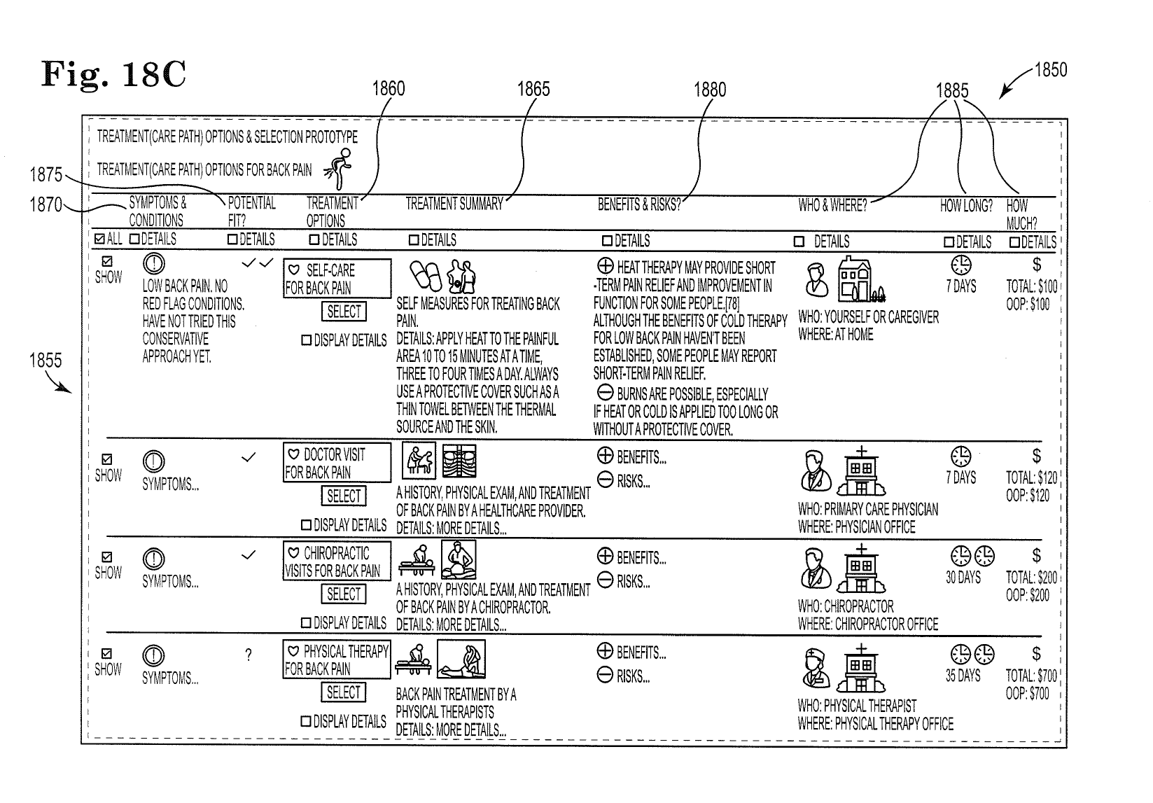

In other implementations, the healthcare path recommendations may be based on analyzing the consumer's engagement with the system 1500 such as via the consumer interface 1530. In one example, the consumer may be experiencing knee pain, and this symptom information may be received as consumer-reported information via the user interface depicted in FIG. 18A. According to FIG. 18A, the user interface 1800 displays a knee problem questionnaire 1802 with pre-defined answers 1804 available for selection by the user about their knee pain symptoms. Upon receipt of selections from the user interface 1800, the healthcare path application 1510 may use the information related to the consumer's knee problem as well as other consumer information stored the by databases 1520 (e.g., medical claims) to generate an initial set of healthcare path recommendations, which may include treatment options such as home icing therapy, a visit to a general practitioner and a visit to a knee specialist.

Generate and Display Customized Healthcare Path Recommendation Content for Display:

Upon generating the healthcare path recommendations, such as an initial set, customized healthcare path recommendations tailored specifically to the consumer may be generated for display 1710. For example, while the initial set of healthcare path recommendations may be generated based on the consumer's medical information in relation to treatment options that are historically used to address a medical condition, the customized recommendations may be tailored to the consumer based on personalized information.

With respect to the consumer's personalized information used to generate the customized recommendations, this may include information about the consumer's health history (e.g., medical clams and past treatments), demographics (e.g., age and gender) and preferences for receiving treatment (e.g., consumer preference-sensitivities related to preferences on engaging in conservative or slower approaches to receiving care, such as self-care, or on engaging in more aggressive or quick approaches to receiving medical services, such as surgery). The personalized information may be used by the healthcare path application 1510 to identify healthcare paths that most closely align with the consumer's needs. For a consumer's age and gender, specific healthcare paths for addressing the consumer's health condition may be more relevant than others. In addition or alternatively, the consumer's preference-sensitivities on treating their medical condition, which may be referred to as risk tolerance, may be used to identify healthcare paths with an acceptable level of risk or may be used to rank healthcare paths according to the consumer's preference-sensitivities. For instance, the preference-sensitivities may indicate the consumer has a level of risk tolerance making the consumer more likely to choose to engage in healthcare paths involving a higher level of risk compared to others, or vice versa, and the customized recommendations may be directed to this preferred level of risk tolerance or the customized recommendations may be ranked according to the consumer's preference-sensitivities.

In some aspects, personalized information may be consumer-reported information received from one or more users of the system 1500 and may be in the form of responses to questions provided by the system 1500 to the user. For example, as the consumer engages with the consumer interface 1530, the consumer's personalized information may be captured as consumer-reported information. In addition or alternatively, a consumer care specialist may enter consumer-reported information on the consumer's behalf during an engagement.

Further, the consumer's personalized information may include information captured in connection with the consumer's search history such as search terms; navigation history such as navigation to the various healthcare, provider and benefit searching functionalities; and selection history such as selected healthcare paths, providers and appointment requests. In addition, where the consumer engages with a consumer care specialist, the consumer's decision support responses may be used. Based on the consumer's engagement with the system 1500, the customized recommendations may identify a variety of treatment options that align with the consumer's pattern of utilization.

The customized healthcare path recommendations generated utilizing the consumer's personalized information may include treatment options that are more cost-effective, within a predefined or closer proximity to the user, and/or personalized to the consumer. The customized recommendations and associated treatment options may be a subset of the healthcare path recommendations initially generated, may include newly generated healthcare path recommendations or both.

In relation to treatment options that are more cost-effective, this may include equivalent or lower cost treatment options in relation to reference costs, such as costs under the consumer's health plan, market averages, fee schedules, and so on. For example, where the consumer is receiving higher cost medical treatment from a provider, a group of eligible, more cost-effective alternatives may be identified based on reference costs. In another example, cost-effective treatment options may be identified in relation to market averages or current fee schedules for medical services. In a further example, where the consumer utilizes the consumer interface 1530 to navigate to a medical treatment, such as for filling a cavity, the customized recommendations may identify dentists with cost-effective prices for this service that align with the consumer's personalized information. In certain implementations, a consumer pattern of receiving higher services, such as engaging in two or more visits from a higher cost provider, may result in the system identifying treatment options that are more cost-effective. In this example, the customized healthcare path recommendations may be generated with little or no consumer involvement with the system 1500, and the consumer may be invited to access the consumer interface 1530 to view the customized healthcare path recommendations.

According to certain implementations, the customized healthcare recommendations including cost-effective treatment options may be identified based on the consumer's health plan and may include estimated cost savings information, monetary-based incentives for engaging in cost-effective treatment options or both. Monetary incentives may include health account credits, rebates to out of pocket costs, lower premiums or deductibles, pre-paid gift cards and so on. Further, where the treatment options involve higher-costs, such as for higher-cost providers, the customized healthcare recommendations may include monetary-based penalties for the consumer engaging in the higher-cost treatment options. The penalties may include additional out of pocket costs, which may or may not contribute to the consumer's deductible or out of pocket maximums.

In relation to treatment options in a closer proximity to the consumer, these options may be for the same or similar medical services or self-care activities engaged in by the user but within a closer proximity to the user's home or work, or another location identified by the user (e.g., through consumer preferences). For example, the consumer's available medical network may be queried for alternative or cost-effective services within a geographic area proximate the consumer (e.g., proximate the consumer's zip code), and a group of in-network providers or resources that support a healthcare path or individual treatment options within the geographic area proximate the consumer may be included in the treatment options. Where the consumer's search history identifies a geographic area in which the consumer is interested in receiving medical services, services within the geographic area that meet the consumer's personalized information may be included in the customized recommendations. In some implementations, the treatment options generated within a certain proximity to the consumer may be based on determining the consumer is traveling long distances to receive medical services. In another example, telephonic, online or mail order treatment options may serve as an alternative to traveling to receive medical services.

In relation to generating personalized treatment options, this may involve determining that the consumer has been, or will be, receiving medical services or engaging in self-care, and identifying opportunities to receive personalized next steps. The personalized next steps may be based on consumer preferences. For example, where the consumer engages in a healthcare path for receiving treatment for back pain or knee replacement, a group of self-care and medical services that involve a conservative treatment approach may be identified as treatment options based on the consumer preference of limiting the amount of medical services received. Where the consumer's search history identifies a search for a specific provider, the provider may be analyzed in connection with the consumer's age, gender and/or personal preferences and included in the treatment options where the provider's qualifications align with the consumer's needs based on their personalized information. In another example, where an appointment search indicates the consumer is interested in receiving care within a short period of time, the customized recommendations may include a list of qualified providers with current availability. In yet another example, the consumer's personalized information may include provider preferences to receiving treatment, and the treatment options may include services from specific providers such as male or female providers, providers that speak foreign languages or that have received cultural training.

The customized healthcare path recommendations may be transmitted via one or more communication channels 1550 of the campaign management application 1540 and displayed via a user interface. In some implementations, the customized healthcare path recommendations may be transmitted directly to the user via the communication channels 1550, such as consumer-preferred communication channels identified from personalized information, or the consumer may be invited to access the system 1500 to review their recommendations. In further implementations, the customized healthcare path recommendations may be displayed during the consumer's real time interactions with the system 1500.

In FIG. 18B, a process flow 1810 illustrates a consumer 1812 engaging with the system 1500 via the consumer interface 1530 both while customized healthcare path recommendations are generated and while a consumer care specialist 1814 reviews the consumer's engagement in real time via a consumer care specialist interface 1537 of the system 1500. According to FIG. 18B, the consumer 1812 may enter their symptoms, conditions or procedures 1816 into the consumer interface 1530 and the consumer's eligibility, gender, age and consumer-entered search terms may be simultaneously logged 1818. As the consumer 1812 navigates through the consumer interface 1530 and enters searches and selections, such as healthcare path treatment option selections 1820, searches for and selections of medical services related to the treatment options 1824 (e.g., providers searches and selections), and cost estimates with associated appointment scheduling 1828, these additional searches and selections may be logged, e.g., at flow steps 1822, 1826, and/or 1830, and used to generate the customized healthcare path recommendations. Thus, turning to FIG. 18C, a user interface 1850, for example, of the consumer interface 1530, provides a listing of customized healthcare path recommendations 1855 tailored to the consumer for addressing their back pain, which may be generated in response to the consumer's engagement with the system at any of the process flow steps 1816, 1820, 1824 and/or 1828. In addition, to displaying the recommendations 1855, the user interface 1850 may display treatment options 1860 for back pain (e.g., self-care, doctor visit, chiropractic visit, or physical therapy visit); treatment summary information 1865; the consumer's symptoms and conditions 1870 (e.g., back pain); potential level of fit (e.g., a custom ranking according to personalized information) 1875; benefits and risks 1880 associated with each treatment option; and detailed recommendation information 1885 (e.g., how, where or how much time consumer can expect to spend when engaging in the recommendation).

In addition, as the consumer enters selections into the consumer interface 1530, this information may be reviewed by the consumer care specialist. For example, returning to FIG. 18B, a consumer's entry of searches and selections e.g., at flow steps 1820, 1824 and/or 1828 may be logged at process flow steps 1822, 1826 and 1830, respectively, and viewed by the consumer care specialist 1814. Over the course of the consumer's navigation through the consumer interface 1530, the healthcare path application 1510 may analyze the logged information and determine that the consumer's interactions with the consumer interface 1530 may not yield an optimal health outcome for the consumer, such as due to unstructured searching or selecting medical services that are not connected to addressing the consumer's health condition, and the consumer may be invited to contact a consumer care specialist, such as via the consumer interface 1530 or over the telephone. In further implementations, the consumer may request to engage with a consumer care specialist by selecting an invite icon 1832 which may be presented at any point in the process flow. In yet further implementations, the consumer care specialist 1814 may engage with the user interface 1530 to inquire about whether the consumer 1812 would like support with their treatment option decisions.

Continuing with the example where the consumer is experiencing knee pain, as the consumer continues their engagement with the healthcare path application 1510, such as in connection with searching for healthcare path treatment options, for providers or for benefit information, the healthcare path application 1510 may determine the consumer requires guidance in making their treatment options that may not be available through the consumer's current mode of interacting with the application 1510 (e.g., via the consumer interface 1530), and the consumer may be requested to contact a consumer care specialist that can guide the consumer through their options to address their knee pain.

Accordingly, in some aspects, step-wise support may be provided at the various stages of the consumer's interaction with the healthcare path application 1510 and recommendations may be tailored to the consumer based on analyzing the consumer's personalized information. In further aspects, this may allow the consumer care specialist to facilitate the user in proactively addressing the consumer's healthcare needs.

Receipt of Selections Related to the Healthcare Path Recommendations:

Continuing with method 1700, the system 1500 may receive selections 1715 from a user related to the consumer's customized healthcare path recommendations. For example, the user may enter treatment options selections for medical services or self-care, comparison selections (e.g., comparing costs between treatment options) and appointment scheduling selections. In some aspects, the selections may be entered from an appropriate interface and/or by communicating directly with a consumer care specialist.

In the example where the consumer is experiencing back pain, the consumer may enter selections related to their choice to engage in self-care using heat therapy as a first step to addressing their health condition, e.g., via the user interface 1850 of FIG. 18B.

Continuing with the knee pain example, the consumer may communicate directly with a consumer care specialist to confer about consumer's treatment options, and the care specialist may enter the consumer's treatment option selection to visit a physician via the consumer care specialist interface 1537.

The customized healthcare path recommendations may enable the consumer to make informed selections about their healthcare. In particular, the recommendations may be generated prior to the consumer scheduling or receiving medical services, such as upon a user accessing the appropriate interface to search for or schedule an appointment for addressing their medical condition, and the recommendations may be transmitted in real time while the user interfaces with the healthcare path application 1510 (e.g., views scheduling selections) or interfaces with a consumer care specialist that may enter treatment option selections on the consumer's behalf. However, the recommendations may be transmitted during any user-involved query according to the present disclosure.

Detect Consumer Information Associated with the Healthcare Path Recommendations:

Continuing with method 1700, information corresponding to the consumer following one or more of healthcare path recommendations may be detected 1720. For example, the information detected may be indicative of the consumer following one or more of the selected treatment options from the recommendations. This information may be detected using a variety of methods, such as through detecting completion of an appointment (e.g., by matching one or more medical codes such as ICD-9 and CPT codes from a consumer's claim with medical codes associated with the healthcare path recommendations); by matching providers, diseases, medical conditions, and/or procedures from medical claims to the healthcare path recommendations; or by self-reporting.

Returning to the back pain example, the information detected may relate to the consumer reporting, e.g., via the consumer interface 1530, that self-care approaches were unsuccessful in relieving the consumer's back pain. As for the knee pain example, one or more medical claims may be detected by the healthcare path application 1510 indicative of the consumer visiting a physician to address their knee problem and that the consumer has been diagnosed with a strained ligament.

### Generate and Display Updated Healthcare Path Recommendations:

Upon detecting the consumer engaged in one or more of the healthcare path treatment options, the recommendations initially provided may be analyzed by the healthcare path application 1510, and updated or new customized healthcare path recommendations may be generated and displayed 1725. For example, where the detected consumer information is indicative of a health outcome, the information may be used in generating updated or new recommendations to address outstanding medical issues the consumer may be experiencing. In a more particular example, where the health outcome is indicative of unsuccessful treatment of the consumer's health condition, the new or updated customized recommendations may include treatment options that are more aggressive compared to those attempted by the consumer. Alternatively, where the health outcome is indicative of a successful treatment that addressed the consumer's health condition, the new or updated customized recommendations may include treatment options that are at the same level or a more conservative level as those engaged in by the consumer. In addition, the new or updated recommendations and details related thereto may be customized based on the consumer's personalized information. Further, where the healthcare path application 1510 receives updated personalized information for the consumer, this information may be used to customize the new or updated recommendations.

Continuing with the example where the consumer is experiencing back pain, based on the self-treatment option of home heat therapy being unsuccessful in addressing the consumer's health condition, the updated customized healthcare path recommendations may be for the consumer to engage in a more aggressive treatment approach involving medical services, such as chiropractic care, and chiropractors identified may specialize in conservative chiropractic care. With respect to the knee pain example, based on detecting the consumer has been diagnosed with a strained ligament, the new customized healthcare path recommendations may provide a group of physical therapists that specialize in treating strained ligaments for individuals with the same age and gender as the consumer.

The new or updated customized healthcare path recommendations may be displayed for user review or the user may be invited to contact a consumer care specialist. For example, the recommendations may be transmitted via one or more of the communication channels 1550 of the campaign management application 1540 directly to the consumer, or the consumer may be invited through one or more of the communication channels 1550 to access the system 1500 or to contact a consumer care specialist. New healthcare selections may be entered, for example, to refine medical service selections, select future medical services or schedule appointments.

Accordingly, by utilizing the system 1500, the consumer may understand how medical choices affect their health and shape future healthcare options.

In further aspects of the present disclosure, the system 1500 may be configured to perform the method 1730 of FIG. 17B for providing customized healthcare path recommendations, and the method 1730 may be implemented in software modules executed by a processor configured to perform the steps of method 1730. According to method 1730, consumer-reported information including symptoms, conditions, and/or past procedures may received during a consumer engagement with a consumer interface communicatively coupled to a computer processor in step 1735. Healthcare path recommendations are generated based on the consumer-reported information and on consumer medical information stored in a database coupled to the computer processor in step 1740. The recommendations may be general healthcare path recommendations historically used to treat health conditions associated with the consumer-reported information. Method 1730 continues with step 1745 where the healthcare path recommendations are transmitted to the consumer interface for display. Alternatively, these recommendations may not be displayed for the consumer's review. When the recommendations are displayed, then in step 1750; personalized information for the consumer (e.g., age, gender, preference-sensitivities and so on) may be received based on these displayed recommendation as well as in relation to the consumer engagement with the consumer interface. In addition or alternatively, personalized information may be received based on consumer engagement activities with the consumer interface in general, e.g., where the recommendations are not displayed. Further, personalized information may be received from the database storing the consumer medical information. Customized healthcare path recommendations may be generated based on the received personalized information including information derived from the consumer engagement in step 1755. The customized healthcare path recommendations may include treatment options for addressing the health of the consumer with cost-effective providers (e.g., relative to reference provider costs such as from consumer medical claims, market averages, fee schedules and so on), providers in a closer proximity to the consumer, and/or providers that are personalized to the consumer. The customized healthcare path recommendations may be transmitted to the consumer interface during the consumer engagement in step 1760.

Estimate Consumer Health Cost Savings and Monetary-Based Incentives or Penalties:

Consumer health cost savings estimates may be calculated for the consumer based on a consumer's cost portion for following the healthcare path recommendations. The cost savings estimate may be displayed in connection with the customized healthcare path recommendations. For example, in FIG. 16, for each of the recommended providers listed, a consumer's estimated cost savings is displayed on the consumer interface 1530.

In some aspects, the consumer health cost savings estimate may be a cost difference between an estimated treatment option cost and a reference cost. The savings estimate may be expressed in estimated consumer cost savings (e.g., savings from deductibles and co-insurance), estimated plan savings, estimated gross savings (e.g., a combination of consumer and plan costs), annual deductible cost savings, and combinations thereof; and the estimate may be on a per medical service basis, per visit basis (e.g., combining savings for all medical services received in a visit), healthcare path basis, healthcare path step basis, and combinations thereof.

With respect to the estimated costs used in calculating cost savings estimate, this is generally a consumer's estimated cost portion (e.g., co-insurance, deductibles and other out of pocket amounts) under their health plan for receiving medical services or engaging in other activities related to their healthcare path recommendations. The consumer's cost portion may be determined from current fee schedules for the same or similar medical services (e.g., from fee schedules for providers). In addition or alternatively, the estimated consumer cost portion may be calculated according to historical cost data such as past medical service claims for the same or similar medical service.

With respect to the reference cost used in the consumer health cost savings estimate, this cost may be based on the consumer's cost portion for engaging in treatment options under their health plan as applied to past consumer claims or experiences, or as applied to industry percentile costs (e.g., a median cost or another percentile cost, e.g., 25^{th} or 75^{th} percentile) and may take into account geographic averages. Further, the reference cost may be prior medical claim costs or other healthcare path treatment option costs for other consumers within the network but as applied to the consumer's health plan. Where past consumer costs are available in addition to the industry percentile costs and/or the prior medical claim or self-care costs for other consumers, the past consumer cost information may be used as the reference cost in calculating the consumer health cost savings estimate.

Further, estimated monetary-based incentives or penalties of the present disclosure may be displayed in connection with the customized healthcare path recommendations in order to provide the consumer with healthcare path recommendations or treatment options that may be more attractive to the consumer, for example, after the consumer has reached their out of pocket maximum.

Calculate Realized Consumer Cost Health Savings and Implement Monetary-Based Benefits or Penalties:

A realized consumer health cost savings calculation may be generated based on comparing cost differences between the consumer's cost portion of the actual treatment option costs for the selected treatment options and the consumer's cost portion of the estimated consumer costs associated with engaging in the treatment options. The realized consumer health savings calculation may be generated subsequent to the consumer following one or more of the recommendations, e.g., receiving medical services or electing to engage in self-care, and may be displayed with updated or new customized healthcare path recommendations. This may enable the consumer to understand how medical or lifestyle choices affect the consumer's cost portion of their medical expenses.

Further, upon the system 1500 confirming that the consumer engaged in treatment options associated with monetary-based incentives or penalties, such as by detecting a consumer's medical claims, the incentives may be awarded to or penalties may be incurred by the consumer.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included in at least one embodiment of the present invention. Therefore, it should be appreciated that two or more references to “an embodiment” or “one embodiment” or “an alternative embodiment” or “one example” and “an example” in various portions of this specification are not necessarily all referring to the same embodiment. Furthermore, the particular features, structures or characteristics may be combined as desired in one or more embodiments of the invention.

Similarly, it should be appreciated that in the foregoing description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed is:

1. A computer-implemented method for providing customized healthcare path recommendations, the method comprising:
using a computer processor programmed to:
receive consumer-reported information comprising at least one of symptoms, conditions, or past medical procedures during a consumer engagement with a consumer interface communicatively coupled to the computer processor;
generate healthcare path recommendations based on the consumer-reported information and on consumer medical information stored in a database coupled to the computer processor;
transmit the healthcare path recommendations to the consumer interface for display;
receive personalized information for the consumer based on the displayed recommendations and the consumer engagement with the consumer interface;
generate customized healthcare path recommendations based on the received personalized information and the consumer engagement, the customized healthcare path recommendations comprising treatment options for addressing the health of the consumer, and the treatment options comprising cost-effective providers relative to reference provider costs; and
transmit the customized healthcare path recommendations to the consumer interface during the consumer engagement.

2. The method of claim 1, wherein the personalized information comprises a health history of the consumer, and wherein the reference provider costs comprise provider costs within the health history.

3. The method of claim 1, wherein the treatment options further comprise at least one of providers within a predefined proximity to the consumer or providers that are personalized to the consumer.

4. The method of claim 1, wherein the computer processor is further configured to generate the customized healthcare path recommendations based on a health plan of the consumer.

5. The method of claim 1, wherein the computer processor is further configured to transmit the customized healthcare path recommendations to a specialist user interface communicatively coupled to the consumer interface during the consumer engagement therewith.

6. The method of claim 1, wherein the personalized information comprises at least one of an age or a gender of the consumer.

7. The method of claim 1, wherein the personalized information comprises a consumer preference-sensitivity for receiving healthcare, and wherein the computer processor is further configured to prioritize the customized healthcare recommendations based on the consumer preference-sensitivity.

8. The method of claim 1, wherein the computer processor is further configured to utilize one or more communication channels to transmit a communication to the consumer inviting access to the consumer interface.

9. The method of claim 1, wherein the computer processor is further configured to:
receive a selection of one or more of the treatment options;
detect consumer information corresponding to the consumer following the one or more treatment options from the selection; and
generate updated customized healthcare path recommendations based on the detected consumer information.

10. The method of claim 9, wherein the detected consumer information is indicative of a health outcome.

11. The method of claim 9, wherein the detected consumer information comprises medical claims.

12. The method of claim 9, wherein the detected consumer information comprises self-reported information that the consumer engaged in the selected one or more treatment options.

13. The method of claim 1, wherein the healthcare path recommendations further comprise an estimated cost savings for the treatment options under a health plan of the consumer.

14. The method of claim 13, wherein the computer processor is further configured to:
detect consumer information corresponding to the consumer following one or more of the treatment options; and
calculate a realized cost savings by comparing an actual cost for the detected consumer information with the estimated cost for the one or more treatment options.

15. The method of claim 1, wherein the treatment options further comprise monetary-based incentives associated with the cost-effective providers.

16. The method of claim 15, wherein the treatment options further comprise higher-cost providers, and wherein the higher-cost providers are associated with monetary-based penalties.

17. A computer-implemented method for providing a consumer with customized healthcare path recommendations, the method comprising:
using a computer processor configured to:
receive consumer-reported information related to at least one of symptoms, conditions or procedures related to a consumer health condition during a consumer engagement with a consumer interface communicatively coupled to the processor;
generate healthcare path recommendations based on the consumer-reported information and on consumer medical information stored in a database coupled to the computer processor;
receive personalized information for the consumer based on consumer engagement activities with the consumer interface and from the database storing the consumer medical information, the personalized information from the database received based on the consumer-reported information;
generate customized healthcare path recommendations based on the received personalized information, wherein the recommendations comprise treatment options for addressing the consumer health condition; and
transmit the customized healthcare path recommendations to the consumer interface during the consumer engagement.

18. The method of claim 17, wherein the consumer engagement activities comprise at least one of navigation through the consumer interface, entry of healthcare searches into the consumer interface, or entry of healthcare selections into the consumer interface.

19. The method of claim 17, wherein the computer processor is further configured to transmit the customized healthcare path recommendations to a specialist user interface communicatively coupled to the consumer interface during the consumer engagement therewith.

20. The method of claim 19, wherein the computer processor is configured to generate and transmit a message to the consumer interface inviting the consumer to engage with the specialist user interface, the message generated based on an analysis of the logged consumer engagement activities.
